(19) United States
(12) Patent Application Publication
(10) Pub. No.: US 2011/0216640 A1
(43) Pub. Date: Sep. 8, 2011

(54) UNIVERSAL MULTIMEDIA DISTRIBUTION, STORAGE, AND PLAYBACK SYSTEMS, AND METHODS

(76) Inventor: James Curtis, Dallas, TX (US)

(21) Appl. No.: 13/108,837

(22) Filed: May 16, 2011

Related U.S. Application Data
(63) Continuation-in-part of application No. 12/839,294, filed on Jul. 19, 2010.
Application No. 12/839,294 is a continuation-in-part of application No. 12/505,342, filed on Jul. 17, 2009.

(51) Int. Cl. G11B 7/00

(52) U.S. Cl. 369/100; G9B/7

(57) ABSTRACT

Universal multimedia distribution, storage, and playback systems, devices, and methods are disclosed herein. A media distribution kiosk located at a retail establishment provides a user with access to a multitude of different forms of digital multimedia that may be purchased and downloaded onto a portable media transporter device. The kiosk includes a non-volatile storage means capable of HTTP communications, allowing multiple kiosks to share and balance storage resources within a storage cloud. Metadata tagging of stored digital media provides object-based storage, allowing efficient search and retrieval of digital media. A media player and a portable media transporter device are capable of directly accessing the kiosk cloud storage to access the media stored thereon. Information from social networking utilities may be incorporated into the stored digital media metadata to influence ratings and performance metrics.

### CROSS-REFERENCE TO RELATED APPLICATIONS

This application is a continuation-in-part of U.S. patent application Ser. No. 12/839,294, filed on Jul. 19, 2010, which is a continuation-in-part of U.S. patent application Ser. No. 12/505,342 filed on Jul. 17, 2009.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates generally to digital multimedia content, and more specifically to devices, systems, and methods for distributing, transporting, storing, and playback of multimedia content.

2. Description of the Related Art

In recent years, consumers of digital media have seen a growing proliferation of various types of devices and systems for accessing, storing, and viewing multimedia content that is acquired via data networks such as the Internet. For example, a number of online media distributors offer consumers having interne access, the ability to purchase and download video and audio content via proprietary software that is connected to large content databases. The proprietary software permits consumers to store the media content on personal electronic devices such as a personal computer, laptop computer, personal digital assistant (PDA), personal media player, or mobile phone. Consumers may then play the content on such devices or transfer the content to other devices for storage and playback.

However, persons in approximately forty percent of households in the United States are not able to access the Internet via broadband. In fact, many households do not have access to the Internet at all. As a result, it is much more burdensome or impossible for individuals living in such households to acquire media content through the Internet. The majority of consumers not having Internet access but desiring to acquire and use digital multimedia content have until recently, had only a few available options. One option is that media content can be purchased, or rented from a retail establishment located at a site physically remote from the consumer's home. After acquiring the media, the consumer can view and/or listen to the content via a portable or fixed playback device. In the case of media acquired via rental, the media must be returned by the consumer, an often burdensome task.

Equally burdensome for the consumer who purchases media is the task of storing said media in an orderly manner and protecting it from being damaged. Because most media is still distributed in physical media device formats such as DVDs and CDs (containing video, audio, and gaming products), most consumers have accumulated a substantial number of purchased discs and other assorted media that is stored in a disorganized manner and is often unprotected from damage in the consumer's household. Devices and other systems disclosed in the prior art have sought to improve upon the means by which consumers acquire, store, and playback multimedia content.

One such system is disclosed in U.S. Patent Publication No. 2009/0117846 A1, published on May 7, 2009, and assigned to Apple, Inc. (hereinafter “the Apple '846 publication”). The Apple '846 publication discloses systems and methods that enable a media distribution system to distribute media content to a media device via one or more media distribution kiosks that are connected via a data network to a centralized media storage server. In particular, the Apple '846 publication teaches a portable media device that is configured to establish a connection (wired or wirelessly) to a media distribution kiosk so as to allow a consumer to purchase media content and download it onto his or her portable media device. The portable media device taught by the Apple '846 publication is capable of uploading media to a remote host or other client system.

Other devices disclosed in the prior art, such as the KALEIDESCAPE® 1080p Player (as configured at the time of the filing of this application) (see http://www.kaleidescape.com), are configured to permit consumers to insert optical discs such as DVDs and CDs into a player device which is capable of decrypting the information residing on the discs and storing a copy of the information onto a local or external storage drive. These prior art devices also provide users with easy to use navigational menus for accessing and playing the stored media. The foregoing capability allows consumers to store the media contained on their amassed collection of optical discs into one easily accessible system. However, one drawback of these prior art media player/storage devices is that they are not capable of communicating with a portable media storage device such as might be used in connection with the media distribution system taught by the Apple '846 publication. In fact, such systems are only capable of accessing media stored on optical discs or via data networks.

Other systems for media distribution found in the prior art suffer from similar drawbacks. One such system is the digital media distribution system disclosed in U.S. Patent Publication No. 2004/0254940 A1, published on Dec. 16, 2004, and naming Hector Cesar Brush as the inventor (hereinafter “the Brush '940 publication”). The Brush '940 publication teaches a media distribution kiosk similar to that which is taught by the Apple '846 publication. A portable digital media card is disclosed that is capable of communicating with the media distribution kiosk such that media is transferred to said media card. The Brush '940 publication further teaches a media player that is capable of receiving, reading, and storing the information residing on the portable digital media card. One drawback of the system taught by the Brush '940 publication is that the media player disclosed therein is not capable of receiving and reading optical discs. As discussed above, most consumers have a substantial collection of DVDs and CDs. The media player taught by the Brush '940 publication would not be capable of playing such DVDs or CDs, which would require consumers to use a separate player for playback of such media.

Further, existing media distribution systems tend to be stand-alone systems with no or limited ability to communicate with other like systems. Performing media updates on multiple stand-alone systems can be rather burdensome. Also, it is highly inefficient to have a cluster of distribution systems, such as in a shopping mall area, all having the same stored media. Such redundancy is highly inefficient with regards to memory capacity usage. Moreover, to increase memory storage capacity, it is necessary to upgrade each distribution system, which is even more burdensome than merely updating the media. It is the object of the invention disclosed herein to remedy these and other deficiencies found in the prior art.

### BRIEF SUMMARY OF THE INVENTION

The present invention provides a media distribution kiosk apparatus, the apparatus comprising: a non-volatile digital storage device for the storage of a plurality of unstructured digital media formats, the storage device including an HTTP communication interface.

The present invention further provides a media distribution system, the system comprising: a plurality of media distribution kiosks, two or more of the plurality of kiosks including a non-volatile digital storage device for the storage of a plurality of unstructured digital media formats, each storage device including an HTTP communication interface.

### BRIEF DESCRIPTION OF THE SEVERAL VIEWS OF THE DRAWINGS

A more complete understanding of the universal multimedia distribution, storage, and playback systems and methods of the present invention may be had by reference to the following detailed description when taken in conjunction with the accompanying drawings, wherein:

FIG. 1 is a block diagram of a preferred embodiment of the universal multimedia distribution, storage, and playback system of the present invention;

FIG. 2 shows a perspective view of a preferred embodiment of the media distribution kiosk of the universal multimedia distribution, storage, and playback system of the present invention;

FIG. 3 shows a perspective view of a preferred embodiment of the portable media transporter device of the universal multimedia distribution, storage, and playback system of the present invention;

FIG. 4 shows an alternate embodiment of a portable media transporter device of the universal multimedia distribution, storage, and playback system of the present invention;

FIG. 5 is a block diagram providing a general overview of the hardware and capabilities of a preferred embodiment of the media storage and playback device of the universal multimedia distribution, storage, and playback system of the present invention;

FIG. 6 is a block diagram of a preferred embodiment of the hardware associated with the media storage and playback device of the universal multimedia distribution, storage, and playback system of the present invention;

FIG. 7 is a block diagram of a preferred embodiment of the software associated with the media storage and playback device of the universal multimedia distribution, storage, and playback system of the present invention;

FIG. 8 is a depiction of one embodiment of the user interface of the media distribution kiosk, highlighting the choices presented to the user for the various media content available on the system;

FIG. 9 is a depiction of the user interface embodiment showing the welcome screen for a user;

FIG. 10 is a depiction of the user interface embodiment showing the movie search feature presented to the user;

FIG. 11 is a depiction of the user interface embodiment showing the results of a movie search presented to the user;

FIG. 12A is a depiction of the user interface embodiment showing a specific movie selection chosen by the user;

FIG. 12B is a depiction of the user interface embodiment showing a preview of the specific movie selection chosen by the user;

FIG. 13 is a depiction of the user interface embodiment showing the shopping cart feature and contents chosen by the user;

FIG. 14 is a depiction of the user interface embodiment showing the payment method screen for the user at checkout;

FIG. 15 is a depiction of the user interface embodiment showing the alternate payment prompt screen for the user;

FIG. 16 is a depiction of the user interface embodiment showing the payment completion screen for the user;

FIG. 17A is a depiction of the user interface embodiment showing the media transfer screen for the user, with a status bar depicting status of the transfer to a USB connected device;

FIG. 17B is a depiction of the user interface embodiment showing an alternate media transfer screen for the user, with a status bar depicting status of the transfer to an iPod® device;

FIG. 17C is a depiction of the user interface embodiment showing an alternate media transfer screen for the user, with a status bar depicting status of the transfer to an USB flash drive device;

FIG. 17D is a depiction of the user interface embodiment showing an alternate media transfer screen for the user, with a status bar depicting status of the transfer to an optical storage device;

FIG. 18 is a depiction of the user interface embodiment showing the media transfer completion screen for the user;

FIG. 19 is a depiction of the user interface embodiment showing the payment completion screen for the user;

FIG. 20 is a depiction of the flow diagram of another embodiment of the user interface, showing additional process flow as presented to a user;

FIG. 21 is a block diagram of an embodiment of the video on demand system architecture; and

FIG. 22 is a flow diagram of the steps taken by the embodiment in converting a received video stream into an encrypted signal for video on demand playback with a media storage and playback device.

Where used in the various figures of the drawings, the same numerals designate the same or similar parts. Furthermore, when the terms “top,” “bottom,” “first,” “second,” “upper,” “lower,” “height,” “outer,” “inner,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific width, length, and similar requirements will likewise be within the skill of the art after the following teachings of the present invention have been read and understood.

Preferred embodiments of the universal multimedia distribution, storage, and playback systems and methods according to the present invention will now be described in detail with reference to the accompanying drawings.

### DETAILED DESCRIPTION OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

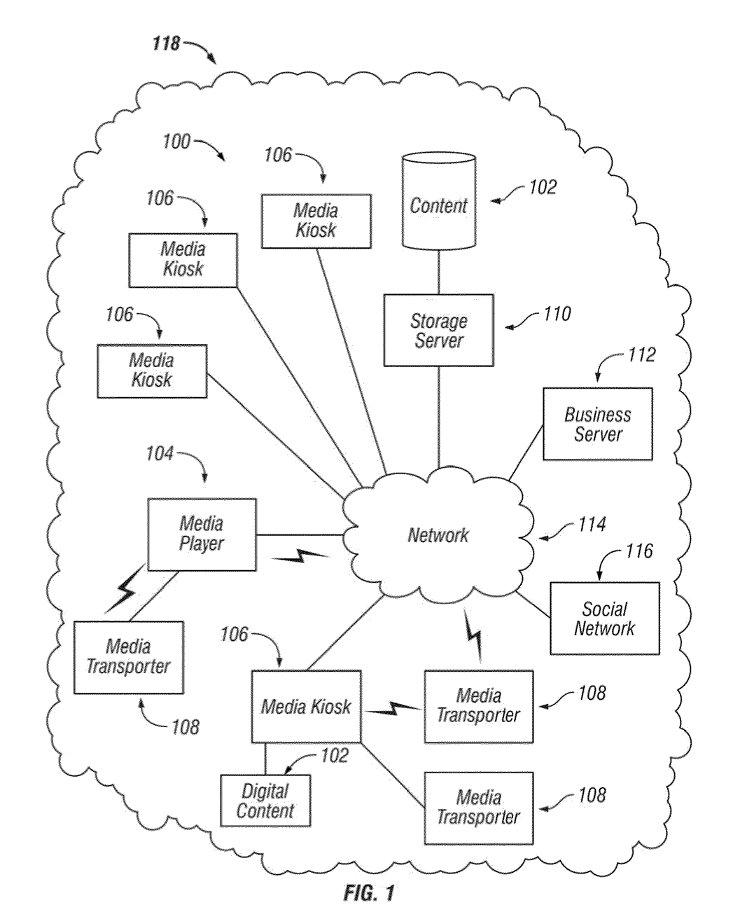

Referring to FIG. 1, a block diagram of a preferred embodiment of the universal multimedia distribution, storage, and playback system 100 of the present invention. The system 100 includes one or more media distribution kiosks 106 that may be placed at diverse commercially advantageous physical locations such as retail establishments, transportation hubs (airports, bus and train stations, etc.), restaurants, and any other place where potential consumers may congregate. Users of the system seeking to access media content may do so through a media distribution kiosk 106. The media distribution kiosk 106 is connected to a data network 114.

It is contemplated that the data network 114 may include one or more of the Internet, a private network, mobile data network, satellite network, a public switched telephone network (PSTN), or any other network capable handling the communication of information. Although the media distribution kiosk 106 of the preferred embodiment communicates with the data network 114 via a wired connection, it is contemplated that alternate embodiments of the kiosk 106 may be configured to communicate with the data network 114 via wireless means.

Media content 102 accessible for distribution to users of the system 100 resides in one or more storage systems 102 controlled by at least one storage server 110. Examples of media content 102 stored for distribution on the storage system 102 include, but are not limited to, movies, music, electronic books, audio books, gaming software, ring tones, television and sports videos, music videos, photographic images, computer software, and electronic tickets for entertainment such as movies, theater, concerts, motorsports, sporting events, internet protocol television (IPTV), video on demand (VOD), and the like. The storage server 110 is electronically coupled to the kiosk via the data network 114, providing for communications with the media distribution kiosk 106. In a preferred embodiment content updates may be downloaded to the kiosk from the storage server 110 through the network 114, but they are stored at the media kiosk. The kiosk 106 provides internal storage for all or some portion of available media content 102. Other streaming content (for example, IPTV and VOD) may be received by the kiosk 106 via internet, wireless, or satellite connection, encrypted, and buffered or archived on the storage server 110, saved on the media transporter device 108 or streamed to the media storage and playback device 104.

The media distribution kiosk 106 provides an interface through which a user may communicate with the data network 114 to access stored media content 102. As will be described in more detail below, the media distribution kiosk includes a display device (with a graphical user interface, or “GUI”) and a human interface device (such as a keyboard, touchscreen, trackball, etc.) that enable the user to interact with the kiosk. When a user initiates contact with the media distribution kiosk 106, information is provided to the kiosk by the user or a device controlled by the user that identifies the user and other information associated with the user. Such information may include user's financial information (credit card and bank account information), the user's media preferences (types of movies or song genres preferred), the user's purchasing history, and any discounts or credits that the user may be able to allocate to future purchases. This user information is then transmitted to a business server 112 connected to the data network 114.

The kiosk 106 includes a browser application that permits the user to navigate menus of a virtual media store residing on the business server 112 and accessible through the kiosk 106. The browser permits users to locate desirable media. When desirable media is found by the user, the user may elect to purchase or otherwise acquire (rental, license, etc.) a copy of the media for download. The business server determines whether to authorize the user's request to download media based upon the information provided by the user and other financial information obtained through the data network or residing within the business server itself. If the business server determines that the requested download should be authorized, the business server then authorizes the user to download the media.

The media distribution kiosk 106 is configured to communicate with a media transporter device 108 that is capable of docking with the kiosk 106 and is used to store and transport media content for further use by the user. The media transporter device 108 may contain information pertaining to the user that may be exchanged with the media distribution kiosk 106 to enable identification of the user and to facilitate the handling of financial information needed to gain authorization to acquire media. Although the preferred embodiment of the media transporter device 108 functions primarily as a data storage device, alternate embodiments may include devices that are capable of providing the user with the ability to browse the virtual media store wirelessly by using the device and to download and play the media on said device. Such an alternate embodiment will be disclosed below with reference to FIG. 4.

Once a download is authorized by the business server 112, the storage server 110 acquires the selected media and transmits it to the kiosk 106 for download to the user's media transporter device. The kiosk 106 then transmits the media to the media transporter device 108, which is docked to said kiosk 106. The user may continue in the manner described above to select additional media content for download or terminate his or her session with the media distribution kiosk 106. The media transporter device, in its preferred embodiment is small enough that it is easily portable by the user, allowing the user to transport it elsewhere for further use.

Still referring to FIG. 1, the universal multimedia distribution, storage, and playback system 100 of the present invention includes a media storage and playback device 104 that is capable of exchanging information with the media transporter device 108. The media storage and playback device 104 includes at least one means for receiving the media transporter device such that communication may occur between the two devices. In the presently preferred embodiment, a PCMCIA slot integrated into the media storage and playback device, which is further connected to an eSATA port, provides the means receiving the media transporter device such that communication may occur between the two devices. Information read from the media transporter device 106 is stored in data storage systems (either internal or external to the media storage and playback device) accessible by the media storage and playback device 104. The media storage and playback device 104 is capable of acquiring information from other media formats such as optical discs, secure digital (SD) cards, memory sticks, compact flash cards, and USB flash drives. The media storage and playback device 104 is capable of transcoding information stored on media having copy protection systems that are configured to prevent unauthorized copying. Such copy protection systems include Content Scrambling System (CSS) and Advanced Access Content System (AACS). Once transcoded, the information is stored to the storage system(s) accessible by the media storage and playback device 104.

The media storage and playback device 104 is also capable of exchanging information with other devices such digital cameras, video cameras, scanners, printers, personal computers, personal digital assistants (PDAs), and mobile phones. Further, the media storage and playback device 104 is capable of communicating with one or more data networks 114 for various purposes such as to download programming content, to download media via the business server, online gaming, email, and to access the World Wide Web (WWW).

The media storage and playback device 104 includes software applications capable of providing a user with interactive menus for accessing stored media, for obtaining television programming information, for accessing the WWW, for navigating the virtual media store, for recording television. Playback of media is accomplished via peripheral devices such as one or more televisions, monitors, projectors, speakers, and/or any other devices adapted for such purposes.

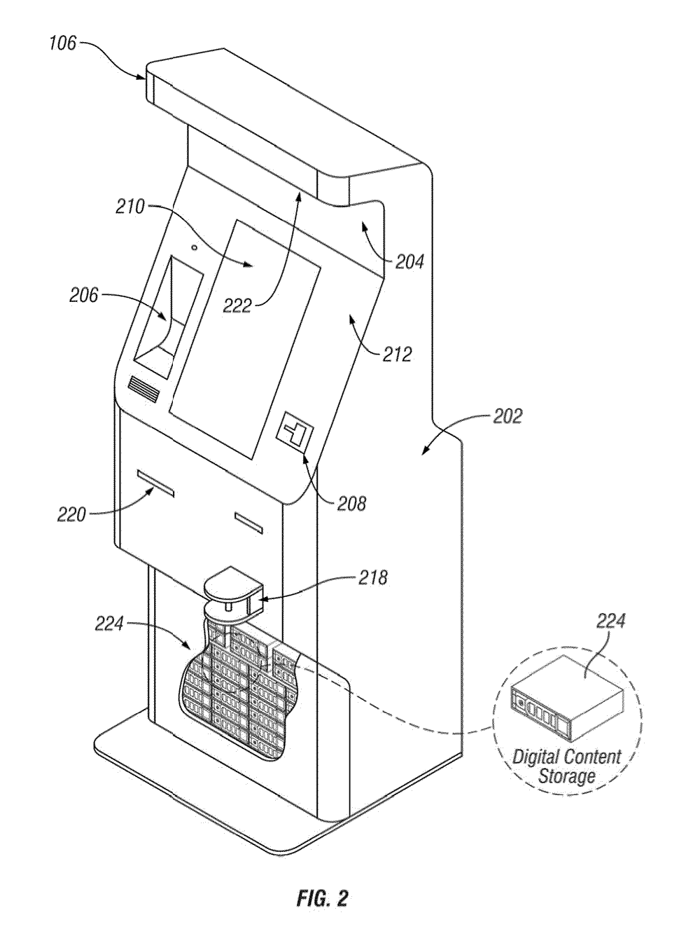

Referring now to FIG. 2, a perspective view of a preferred embodiment of the media distribution kiosk 106 of the universal multimedia distribution, storage, and playback system 100 of the present invention. The kiosk 106 shown in the preferred embodiment includes a stand-alone housing 202 that is similar in form to a personal computer or automatic teller machine (ATM) but it should be understood that alternate embodiments may have a form that is substantially different. For example, an alternate embodiment of the kiosk 106 may be installed as a panel, flush with a wall (not shown), or any other means for mounting.

The kiosk 106 includes a computer processing device (not shown) upon which an operating system operates to control at least one onboard storage device (such as a hard disc drive) for non-volatile storage of data and a display 210 permitting the user to visually perceive a graphical user interface (GUI) (not shown) that may be navigated via touch screen interface 210. The operating system may be any commercially available operating system, such as Microsoft® Windows or the like, or may be a proprietary system developed solely for the kiosk system. The GUI is generated and controlled by computer software running on the onboard computer processing device. Alternate embodiments of the kiosk 106 may utilize input device controllers such as a keyboard and mouse or trackball. The kiosk 106 further may include a docking port 206 for receiving the media transporter device 108 and speakers 222 allow for audio to accompany playback of media samples containing audio.

Onboard buffering and/or storage of digital media content is provided by one or more hard drives 224 configured in an array for access by the computer processing device. In the present embodiment the kiosk 106 utilizes a non-volatile storage means consisting of a redundant array of independent discs (RAID) in a hot-swappable arrangement for data continuity. This storage means allows for replacement of failed hard drives without interruption of data service. Further, this storage means is readily expandable in capacity and can be scaled by the addition of hard drives or replacement by drives of greater capacity. In another embodiment the kiosk 106 utilizes a RAID arrangement in addition to a single or JBOD hard drive arrangement, with vital data stored to the RAID drives for redundancy and other non-critical data (such as temporary user, environment, or operating system swap space data) stored on the JBOD drives.

The hard drive array in the present embodiment utilizes object-based storage strategies for tracking and accessing the unstructured digital media content available on the kiosk 106. Unstructured data—such as—is difficult to manage without object-based storage strategies because little is known about the context in which the data was created as well as the content of the file. Object-based storage utilizes metadata associated with each data file to provide context and content information, which allows for faster and more meaningful search and access of stored data. For example, a video data file includes the video data in addition to information such as the author, title, date prepared, date saved, version, location data where the video was recorded, information regarding the reason for the video, etc. Thus, the data file and associated rich metadata serve to create an “object.” Searches initiated by a kiosk 106 user may therefore be performed on a variety of search criteria based upon the metadata provided in the object store. For example, the metadata associated with a file may further include information such as popularity, ranking, demographics of viewers/listeners, freshness (i.e., date and time added/accessed/modified), etc.

Further, the hard drive array in the embodiment supports an HTTP communications protocol, allowing access of the hard drive array over the Internet or intranet to allow it to serve as cloud storage. The term “cloud storage,” as used herein, refers to non-volatile storage resources that are shared among a group of connected kiosks. The connection may be private (restricted intranet) or public (Internet). If the connection is private, then the storage resources may be shared among the connected kiosks. For example, a shopping mall may have several kiosks 106 in various locations. With common HTTP communications, each kiosk 106 may balance its storage needs among the other kiosks 106, effectively treating the combined storage capacity of all kiosks into a storage “cloud.” In doing so, increases in storage capacity of one kiosk benefits every other kiosk, delaying or even eliminating the need for further storage capacity upgrades. Moreover, it is possible to shift certain digital media to locations where it is more appropriate for access. For example, videos of a certain genre may be popular or appropriate at a first location, but not at another location. Based upon sales and genre metadata associated with the particular video files, low performing videos may be moved to the high performing location (or locations) thus ensuring fast access during frequent purchases. If the connection is public (Internet), then the connected kiosks may share some or all of the storage resources with other computing platforms over the Internet. For example, referring again to FIG. 1, the kiosks may receive updates to available digital media directly from the media producers 102 or from rating services 116 that track digital media ratings and performance metrics. Available digital media may also receive updates to the object metadata tags directly from social networking services 116, allowing the kiosks 106 to dynamically maintain up-to-date social taxonomy, ratings, ranking, and metrics for the available media. The connected kiosks may also post announcements, offers, requests for comments, etc. to social networking services 116 including Facebook, Twitter, MySpace, Linkedln, YouTube, and the like, with feedback and responses used to directly or indirectly update relevant digital media object-based metadata.

As part of the connected storage cloud, user media players 104 or media transports 108 may utilize HTTP communications to directly access digital media stored within a connected kiosk 106, without actually downloading a copy. This allows the media player 104 or media transport 108 to access and playback the digital media without requiring large amounts of storage local to the player or transport. Instead, over the storage cloud the memory capacity of the kiosk 106 is treated as memory that is directly accessible by the media player 104 and media transport 108 devices. Information regarding access and playback rights to specific digital media is maintained within the object tagging system or the kiosk 106 database, allowing control of a user's access. Further, using object tagging allows the kiosk 106 to partition its storage areas among groups, thereby restricting overall access as necessary. For example, a kiosk 106 may reserve a large portion of its storage for local use, with another portion available to other kiosks and yet another portion available to subscribing users based upon access privileges.

Referring again to FIG. 2, although the preferred embodiment of the media transporter device 108 is coupled to the kiosk 106 via the aforementioned docking port 206, alternate embodiments of the media transporter device (hereinafter a “smart media transporter device”) are capable of establishing a virtual wireless dock with the kiosk 106. A sensor 212 located within the kiosk 106 is capable of determining that a smart media transporter device is within close proximity to the kiosk 106. Once a smart media transporter device is within a suitable range, the device is authenticated as an authorized device and a connection is established between the kiosk and the device. An antenna 204 located on the kiosk provides for transmission and reception of data signals between a smart device and the kiosk. The antenna 204 may also provide for transmission and reception of signals between the kiosk 106 and a data network 114. By utilizing a wireless connection between the kiosk 106 and a data network 114, the kiosk may be placed in any location within the wireless network's reach.

It is contemplated that most users of the system of the present invention will provide financial information to the operator of the system to permit for convenient financial transactions. Such information may include credit or debit card information, bank account information, gift certificates, or any other manner by which money may be debited or credited to an account established for the user. However, the kiosk 106 will also be capable of reading credit/debit/gift cards via a card reader device slot 208 located on the kiosk. The card reader device utilizes the magnetic stripe on the user's card or a transceiver chip located in the card (such as an RFID chip or the like).

Another capability of the kiosk 106 is to record and dispense materials to the user via a dispensing slot 218. Various items may be recorded by the kiosk and dispensed through the aforesaid slot 218 including, but not limited to, media residing on optical discs (such as Blu-Ray, DVD and CDROM discs), coupons, and other marketing/promotional materials. The foregoing items may be stored within the kiosk itself or in a location accessible by the kiosk. Any known mechanisms for dispensing such items may be utilized. A printer (not shown) within the kiosk is used to print text and/or graphics on paper items, such as receipts or event tickets, to be dispensed 220 to the user.

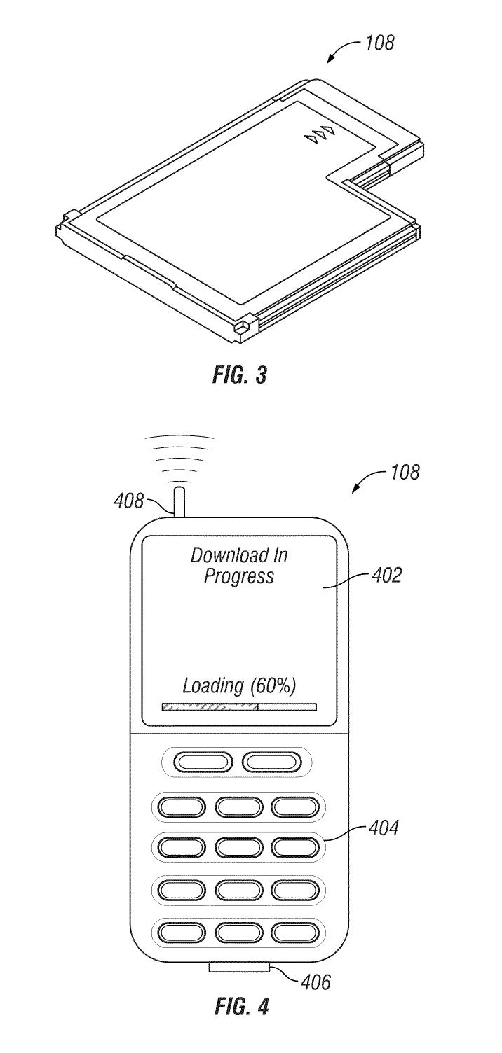

Referring now to FIG. 3, a perspective view of a preferred embodiment of the portable media transporter device 108 of the universal multimedia distribution, storage, and playback system of the present invention. The media transporter device 108 is capable of both storing media and other information in a non-volatile memory device, such as a hard drive or flash drive, and also of communicating with the media distribution kiosk 106 and the media storage and playback device 104. Although the preferred embodiment of the transporter device is a 54 mm EXPRESSCARD® (see http://www.expresscard.org), a device well known to those of ordinary skill in the art, it is contemplated that any device having the foregoing capabilities may be used.

It is preferable that the transporter be of a size and form that is convenient for a user to carry on his or her person. The transporter should also have a storage capacity that is sufficiently large to contain at least one full length movie in high definition format. It should be apparent to those skilled in the art that alternate embodiments of the transporter may have memory capacities that vary in size but which are sufficient to contain movies, music, video games, and other media in quantities desired by the consumer.

Referring now to FIG. 4, an alternate embodiment of a portable media transporter device of the universal multimedia distribution, storage, and playback system of the present invention. As described above, alternate embodiments of the media transporter device (“smart media transporter devices”) may have additional capabilities. The smart media transporter device 108 may include devices such as a cellular telephone, personal digital assistant (PDA), smart phone, laptop computer, mobile media player, or other device capable of wireless communications.

The smart media transporter device 108 is equipped with a screen 402 and keypad 404 that permit a user to view and navigate a GUI displayed by said device. The smart media transporter includes a processor and software applications providing the device with the capability to playback media. The smart media transporter device also includes a wireless transceiver and is configured to wirelessly communicate with the media distribution kiosk and media storage and playback device, and permits the user to utilize the GUI of the smart media transporter device to interact with the virtual media store. Alternatively, the smart media transporter device may wirelessly communicate with the business server and storage server without the necessity of interacting with the media distribution kiosk. However, such functionality may be disabled by the operator of the media distribution system if it is desirable to require the user to be present at the location of the kiosk in order to download media. Further, should the ability of the smart media transporter device to wirelessly communicate be disabled, a communications port 406 located on the device is capable of coupling to a corresponding docking port on the kiosk such that the device and the kiosk can exchange information through said ports.

Another embodiment of the portable media transporter device 108 is a preloaded memory stick, such as a USB flash memory device or the like, that may be supplied from the kiosk or other commercial retail vendor. For example, s retail vendor may preload the device with digital movies, games, music, images, software, etc., or a combination of such digital media content. This preloaded media may be utilized to support a certain marketing effort by the retailer for promotional use or may be provided in the same fashion that prepaid gift and calling cards are provided. For example, a point of sale display may house the portable memory devices that are preloaded with current movie releases for purchase or rental. A consumer may then purchase the movie for playback on the media storage and playback device 104. The preloaded media may also contain encoded instruction to notify the media storage and playback device as to whether the media was intended for rental or ownership. If, for example, the media content is a movie that is for rental, the encoding may include information regarding the number of times the consumer is allowed to view the movie or may include the duration of time during which the movie is available for viewing. Once the viewing limits are met, the media storage and playback device automatically deletes the media file and the portable memory device may be utilized as storage for additional media files as the consumer sees fit.

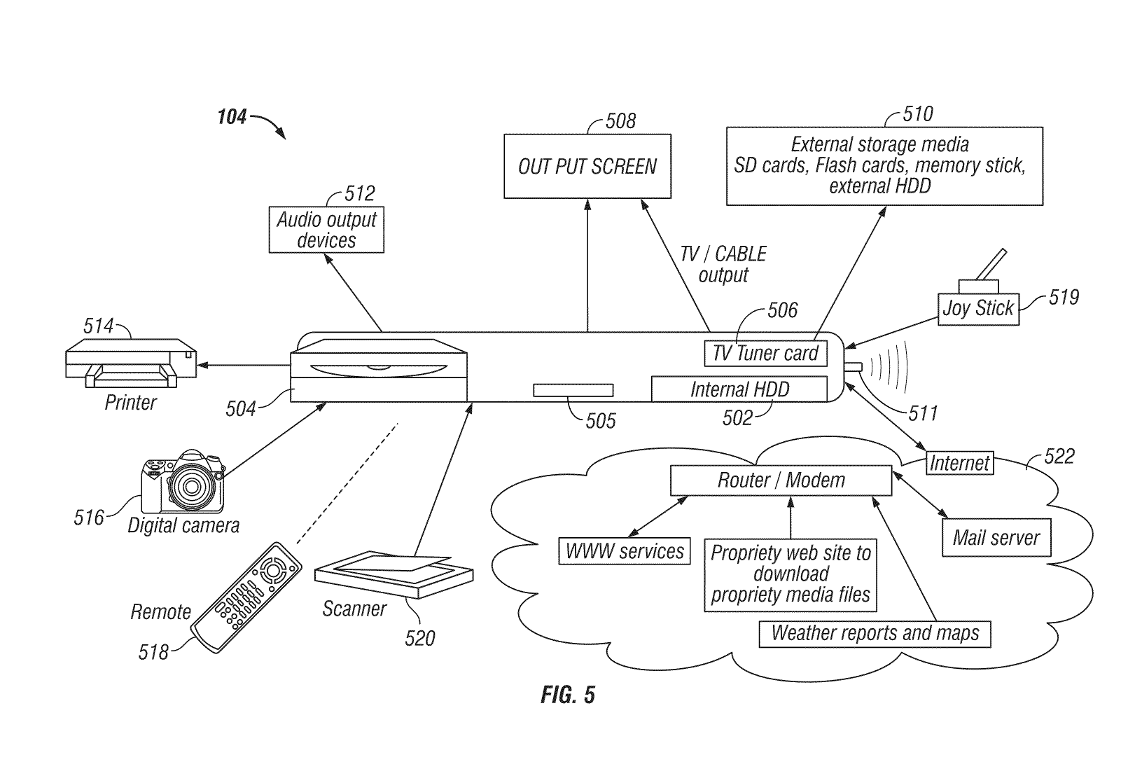

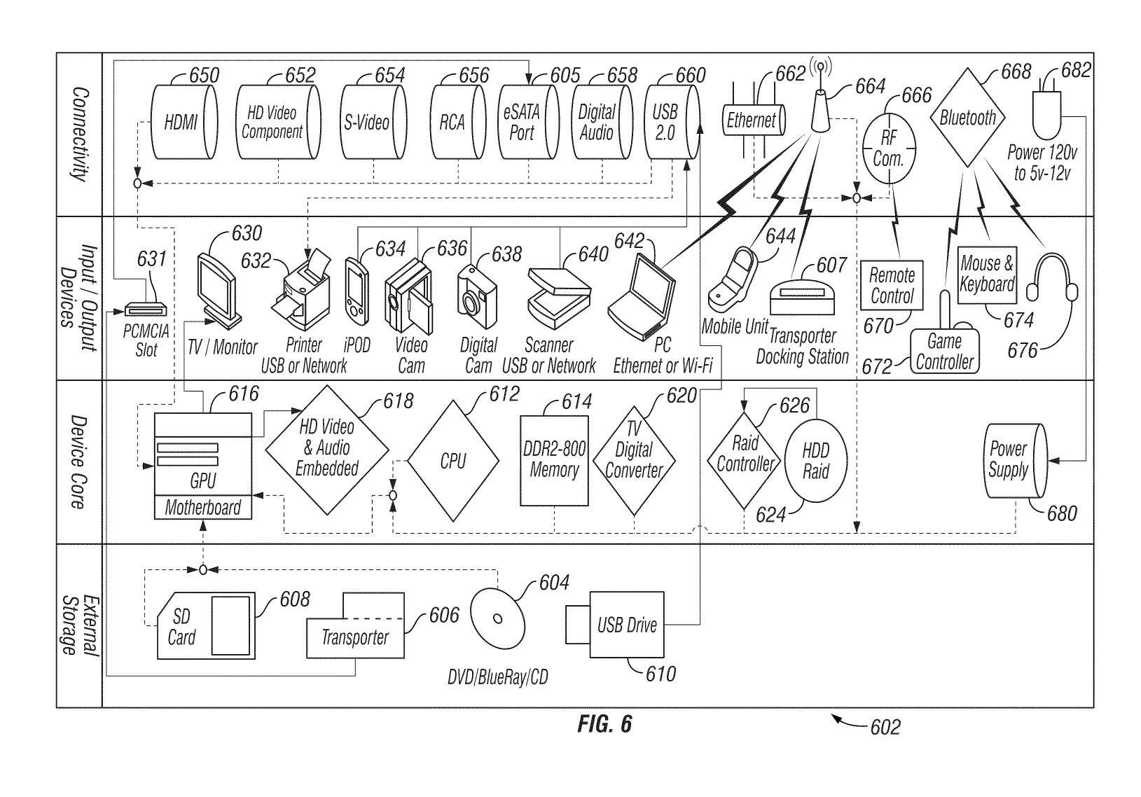

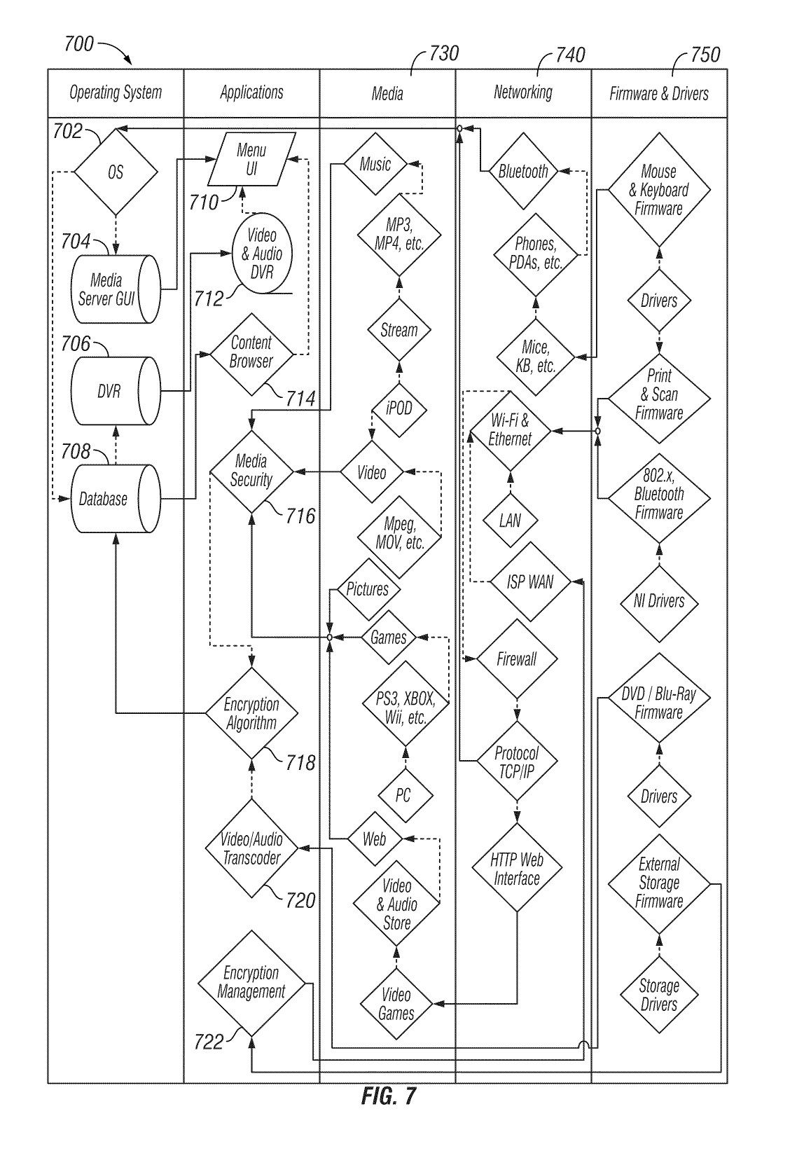

Referring now to FIG. 5, a block diagram of a preferred embodiment of the media storage and playback device of the universal multimedia distribution, storage, and playback system of the present invention, an overview of the capabilities of the device is shown. FIGS. 6 and 7, described in detail below, provide a more detailed illustration of the hardware and software used within the preferred embodiment of the device. The media storage and playback device 104 is capable of transcoding and storing information from a variety of media formats, including optical discs such as DVDs and CDs, as well as memory cards such as the media transporter device. For the purpose herein, the use of the term “transcode” or variations thereon shall be defined to include the term's ordinary meaning as well as any act of decoding for storage and playback, any information that has been encrypted or otherwise coded so as to prevent use by unauthorized persons. The ability of the media storage and playback device to read and store information from both optical discs and memory devices provides an advantage not seen in the prior art.

The media storage and playback device 104 includes a means for receiving physical media devices such as DVDs and CDs (optical discs). In the preferred embodiment of the present invention, the media storage and playback device receives optical discs through a slot 504 on the front face of the device. Likewise, the media storage and playback device includes a second means for receiving physical media devices containing media content. The preferred embodiment of the media storage and playback device includes a slot 505 found on the front face of the device that is configured to accept the media transporter device. In the preferred embodiment, the slot 505 for receiving the media transporter device is a media transporter interface device such as a PCMCIA slot 505 that is further connected to an eSATA port (not shown). Although a PCMCIA slot is discussed in conjunction with the instant embodiment, other interface devices are also contemplated such as serial ports, parallel ports, RS-232, Universal Serial Bus (USB), IEEE 1394, and the like.

Various ports 507 on the front face of the media storage and playback device, as well as ports on the rear face (not shown) are configured to interface with a multitude of peripheral devices, such as audio output devices (speakers) 512, printers 514, digital cameras 516, remote controls 518, scanners 520, gaming controls 519, external hard drives 510, flash cards 510, SD cards 510, memory sticks 510, and video output devices 508. Alternatively, the media storage and playback device may communicate wirelessly with a smart media transporter device via an antenna 511. Additionally, the media storage and playback device is capable of receiving television programming via a television tuner card 506 or directly from a third-party satellite or cable box, and recording such information via DVR hardware and software in HDTV format or standard broadcast format, for playback with any screen aspect ratio. Dual tuners 506 in the media storage and playback device allow for multiple broadcast channels to be received and recorded simultaneously. While dual tuners are discussed, it is possible to have additional tuners and such configurations are within the scope of the present invention.

Once digital information is received and transcoded by the media storage and playback device, the device stores the information in an internal hard drive 502. The downloaded media (e.g., movies, music, photos, games, videos, and VOD/Cable movie service) is stored in the media library in integrated flex memory on the internal hard drive 502 to allow for easy storage and instant playback. The flex memory allows the media library to handle any type of digital file capable of playback on the media storage and playback device. One or more external hard drives may be connected to the media storage and playback device in order to provide additional storage capacity.

The media storage and playback device 104 is capable of establishing communications with a data network 114 such as the Internet 522 or WAN, MAN, LAN, PAN or the like. Thus, a user may access the World Wide Web, email, and the business and storage server through which media may be downloaded directly, without the need to interact with a media distribution kiosk. Again, the operator of the media distribution system 100 may choose to disable this capability if it is desirable to require a user to interact with a media distribution kiosk 106.

Referring now to FIG. 6, a block diagram of a preferred embodiment of the hardware 602 associated with the media storage and playback device of the universal multimedia distribution, storage, and playback system of the present invention. The device core of the media storage and playback device 104 is comprised of a number of components. Note that not all components are shown in FIG. 6, but merely those that are key to the essential functions of the device. For example, a central processing unit 612, volatile memory 614, a graphical processing unit 616 and embedded HD video/audio card 618, a TV digital converter 620, HD video and audio cards 622, a hard drive 624 and controller 626, and a power supply 680 are key components of the media storage and playback device.

As mentioned above, the media storage and playback device can read information from a variety of sources. Optical discs (DVD, BLU-RAY, CD, high definition digital versatile disc (HD-DVD), and the like) 604, the media transporter device 606 (via a PCMCIA slot 631), SD cards 608, and USB flash drives 610 are examples of physical media devices that the media storage and playback device will receive and transcode. Ports (HDMI 650, HD video component 652, S-Video 654, RCA 656, eSATA 605, digital audio 658, USB 2.0/3.0 660, etc.) located on the media storage and playback device support numerous peripheral devices (television 630, printer 632, IPOD® (personal media player) 634, video camera 636, digital camera 638, scanner 640, personal computer 642, etc.). An Ethernet port provides for communications with a data network. In addition, the device is capable of wireless communications via an antenna 664/RF transceiver 666, and BLUETOOTH® 668. Exemplary devices that may communicate with the media storage and playback device through wireless means include personal computers 642, mobile phones/PDAs 644, a transporter docking station 607, remote control 670, gaming controls 672, input devices (mouse/keyboard) 674, and BLUETOOTH® headphones 676.

Referring now to FIG. 7, a block diagram of a preferred embodiment of the software 700 associated with the media storage and playback device 104 of the universal multimedia distribution, storage, and playback system of the present invention. Linux is utilized as the operating system 702 in the preferred embodiment of the media storage and playback device 104. However, those skilled in the art will appreciate that other operating systems, commercial or proprietary, may also be utilized and are within the scope of the invention.

The operating system of the preferred embodiment is adapted to interface with a media server graphical user interface (GUI) that provides the user with the ability to interact with the device. A database of information that has been stored on the device also interacts with the operating system and a DVR application such as MythTV®. The foregoing capability allows the user to access both media imported from external media sources such as optical discs/transporter device, and also television programming received by the device. Additional applications (user interface menu 710, video/audio DVR 712, and content browser 714) provide the user with interfaces through which it may be determined what media is stored in the device and is accessible for viewing.

Optical discs containing various forms of encrypted media content (movies, music, gaming software, etc.) are transcoded using software applications 720 suitable for the tasks. While the preferred embodiment of the media transporter device utilizes the publicly available HANDBRAKE® (see http://handbrake.fr) software application to transcode media supplied by the user, it will be appreciated by those skilled in the art that other applications providing a means for transcoding encrypted information residing on a physical medium (such as DVDs, CDs, BLU-RAY®, etc.) may be used effectively with respect to the present invention. Alternate embodiments of the present invention may utilize other methods for transcoding and storing encrypted media residing on various physical medium such as the methods taught in U.S. Patent Publication No. 2008/0005802 A1 (“DVD Identification and Managed Copy Authorization,” incorporated by reference herein. It is contemplated that the operators of the system 100 will utilize a digital rights management (DRM) system to ensure the integrity of the media being downloaded and stored on the device. For example, in an alternate embodiment of the present invention, such a digital rights management system may embed in media content downloaded by a user, information concerning the number of times the media content may be accessed or a duration during which the media content can be accessed. Software residing in the media storage and playback device will receive the information when the media content is transferred to the device and limit the user's access to the media accordingly.

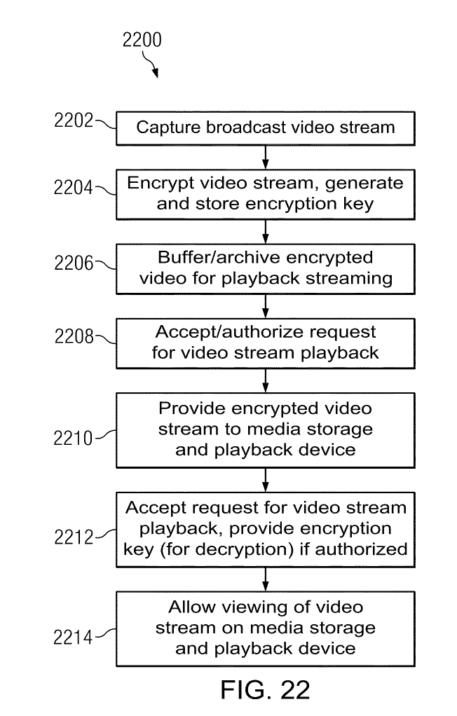

The present embodiment is also capable of accepting, tagging, and encrypting raw video streams for ultimate playback on authorized media transport and playback devices 104. As depicted in FIG. 22, the embodiment first accepts a raw video stream 2102 which is buffered or converted, if necessary, in a storage array 2104 for subsequent processing. The raw video stream is then accepted by a gateway server 2106. In the present embodiment, the gateway server 2106 processes the video by applying object tags and timestamps to the stream. For example, in this embodiment object tags such as OperatorlD, ContentlD, TransationID, and ClientID are assigned to provide a means for uniquely identifying the stream within the database, and for searching video streams and/or portions of videos relevant to a user's search query. Metrics are also accumulated such as timestamps for receipt, encryption, and playback of the video. Object tag metadata may also be used to control how, when, where, and by who the video will be accessed.

The gateway server 2106 provides the unencrypted video stream to a video encryption server 2108 where the video stream is encrypted and returned to the gateway server 2106. The encryption server generates an encryption key during the process, and provides the key to a content security manager server 2110 for storage within an encryption key database 2112. The video encryption server 2108 in the present embodiment utilizes the Advanced Access Content System (AACS) content distribution and digital rights management encryption standard. One of ordinary skill in the art will appreciate that the AACS standard is well known in the digital media industry. Although AACS is utilized in this embodiment, use of other video encryption and access control standards is contemplated and are within the scope of the present invention.

The gateway server 2106 encrypted and tagged video stream is then provided to a VOD server 2114 for distribution over the subscriber network. At this point, the VOD may be transferred to a user's media storage and playback device 104 for later viewing. The VOD may be saved on the playback device 104 for later viewing or may be viewed in “live” streaming, subject to any delays caused by the encryption/decryption/buffering process. The gateway server 2106 also provides video information (object tags and other metadata) to an entitlement server 2112, which acts as a gatekeeper for access to VOD by a user.

The entitlement server 2112 accepts a request for a video from a user playback device 104 and checks to see if the playback device 104 is authorized to view or store the video stream. If authorized, the entitlement server 2112 notifies the VOD server 2114 that the playback device is authorized to receive the video and the video transfer begins. Also, if authorized, the entitlement server notifies the content security manager 2110 that the playback device is authorized to receive the decryption key, which is then provided to the authorized playback device 104 to begin storage and/or viewing of the VOD. The playback device 104 decrypts the video stream and allows playback of the video based upon the user's rights to view, which are dependent upon the rights purchased at the kiosk 106. Although the description of the VOD system mentions independent servers, one of ordinary skill will appreciate that each server may be independent computer server devices operating within the kiosk, or may run upon a single computing device therein. Further, one or more server may run external to the kiosk as a remote networked device accessible by the kiosk.

FIG. 22 depicts a flow diagram of the basic steps of the video stream processing taken by the present embodiment. As previously described, the kiosk captures a broadcast video stream from a cable, satellite, wireless, or Internet feed (such as IPTV) 2202. The video stream is then encrypted and the encryption/decryption key is stored for subsequent access by a user 2204. The encrypted video stream is then buffered (for “live” playback) and/or stored for archival and later playback 2206. A user media storage and playback device requests playback or storage of the video stream, which the system accepts or rejects 2208. The authorized user media storage and playback device then receives the encrypted video stream 2210 and decryption key 2212, and allows viewing of the video stream by the user 2214. VOD access rights are ultimately controlled by the user's privileges to the VOD as established by the user at the kiosk 106.

Encryption algorithms 718 and security systems 716 will be integral to the device such that media content is not impermissibly copied by unauthorized persons. In addition, applications residing in the system will permit remote monitoring of media security and encryption management 722. Remote encryption management systems 722, for example, similar to those utilized by IronKey® systems, will provide the operator of the system with the ability to verify access to the media, disable access to the media, and destroy media content when necessary to maintain the security of the media. This advantage not seen in the prior art playback devices is key in that intellectual property owners can be confident that media used in connection with the present invention will remain secure. As previously mentioned, various forms of multimedia 730 will be accessible on the device and the device will be able to communicate with various data networks 740 to send and receive data. Firmware and other drivers 750 will enable the device to communicate with a wide variety of internal components and external media sources and peripheral devices.

Methods of distributing multimedia to a user in connection with the system described above are also disclosed herein. A first method includes a step of providing a user with access to a media distribution kiosk that is connected to a data network that is further connected to a business server on which marketing information concerning users is stored. A next step provides that the kiosk receives information from the user concerning his or her identity. A next step provides that the kiosk communicates with the business server via the data network to associate the user with marketing information pertaining to the user and other information. Such marketing information may include the user's media preferences, a record of past purchases of media content by the user, the user's age, the user's gender, the user's location of the user's residence, and the location of the retail establishment. A next step of the method involves the server selecting advertising information to transmit to the user based upon the user's identity and the marketing information stored on the business server or an external advertising server. A next step of the method provides that the business server transmits information containing advertising materials to the kiosk. A final step provides that the kiosk prints and dispenses the advertising material to the user. In this manner, the present invention provides an additional advantage not seen in prior art media distribution systems. Namely, the media distribution kiosk may be utilized by the operator of the system to promote products and services within the retail establishment where the kiosk is located, or other products and services not directly associated with the retail establishment.

Another method for media distribution taught herein includes a method for transferring digital marketing content such as video or audio advertising content to a user along with the user's desired purchased or rented media content. The device used to playback the media content and marketing content contains software to monitor and store information pertaining to the user's playback of the marketing content. Such information would include the number of times the media content was played and, if more than one item of marketing content is transferred to the user, which marketing content item was played by the user. This information will then be transmitted to the business server via a data network, or to the kiosk via a transporter device. Based upon a user's playback of the marketing content, the user can earn a financial benefit such as discounts on future purchases of media content or other products, or monetary credits on past purchases or rentals.

For example, a media provider may choose to provide a user with the opportunity to view promotional videos such as advertisements. The advertisement media will be downloaded to the user's media transporter device simultaneously with the media specifically desired by the user. An application residing within the playback device (whether a smart transporter device or a media storage and playback device) will provide the user with the opportunity to view the advertisement media during playback of the desired media or at a different time. If viewed, information pertaining to such viewing will be transmitted to the business server via a data network. Alternatively, such information concerning the user's viewing of the advertisement media may be written back to the media transporter device such that the next time the user permits the transporter device to interact with a media distribution kiosk, said information will be uploaded to the business server. After the business server receives the information concerning the user's viewing of the advertisement media, monetary or other credits/discounts may be allocated to the user's account.

In yet another method for media distribution taught herein, a user is provided with a social networking software application that enables the user and his or her peers to share with one another, their media preferences (favorite movies, music, games, etc.). Based upon the media preferences of a user's peers, the user, using the social networking application or another software application provided to the user, can record and store his or her list of desired media content items and rank them according to their relative desirability. Information associated with the aforesaid list of desired media may be stored on the aforementioned media transport device, the media storage and playback device, the social networking software application, or any other device or application. The list of desired media content items may then be transmitted to the kiosk or business server for storage thereon. One or more of the desired media items identified on the aforesaid list may then be transferred to the media transport device or media storage and playback device for later viewing. It is contemplated that the most desirable media content item on the user's list would be transferred to the user first. Information pertaining to the user's list of desired media content items (and previous lists provided by the user) may be stored on the business server. Marketing information may be provided to the user based upon the contents of the user's list of desired media content items (and previous lists provided by the user).

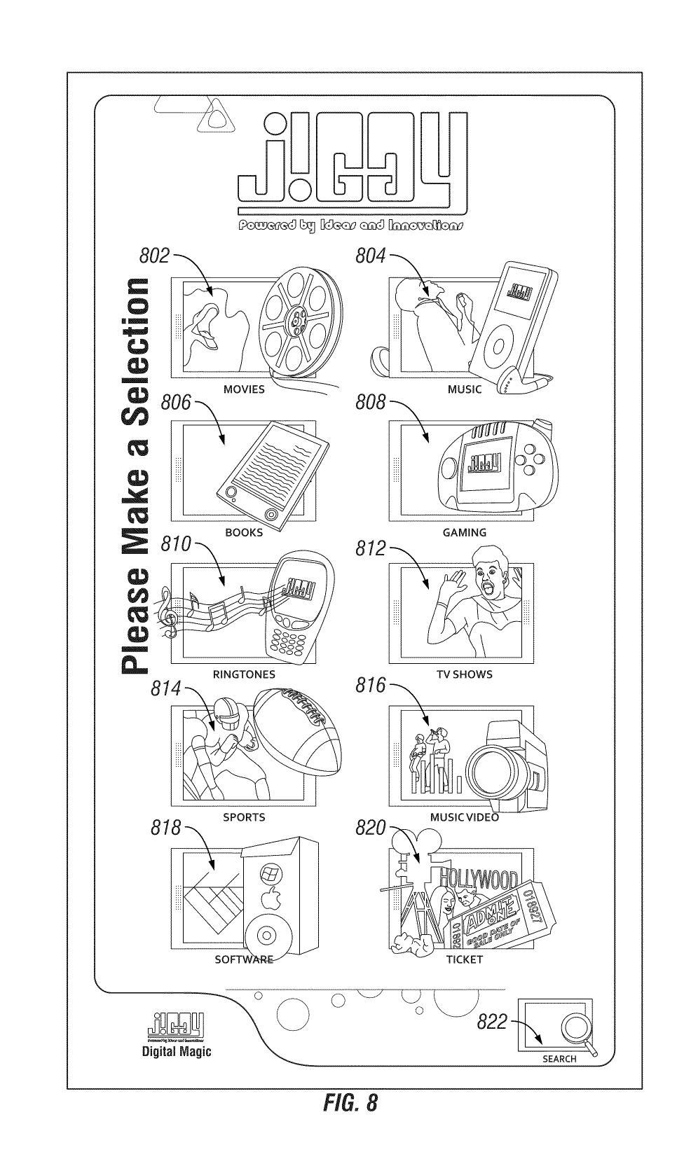

FIG. 8 depicts one embodiment of the user interface of the media distribution kiosk, highlighting the choices presented to the user for the various media content available to a user accessing the kiosk. As shown the system is capable of providing digital media such as movie files 802, music 804, eBooks 806, computer games 808, ringtones 810, television show videos 812, sports videos 814, music videos 816, computer software 818, and electronic event tickets 820 (including, but not limited to, movies, theater, music, sports, art events, and the like). Printouts may also be obtained from the kiosk for items such as sheet music 804, game 808 instructions, software 818 instructions, and event tickets 820. To make a selection, a user touches the desired area of the screen that represents the user's desired item or, if the interface device utilizes a mouse or trackball, a cursor is placed over the desired icon and the select button is chosen. A search feature 822 is also available and is described below in greater detail.

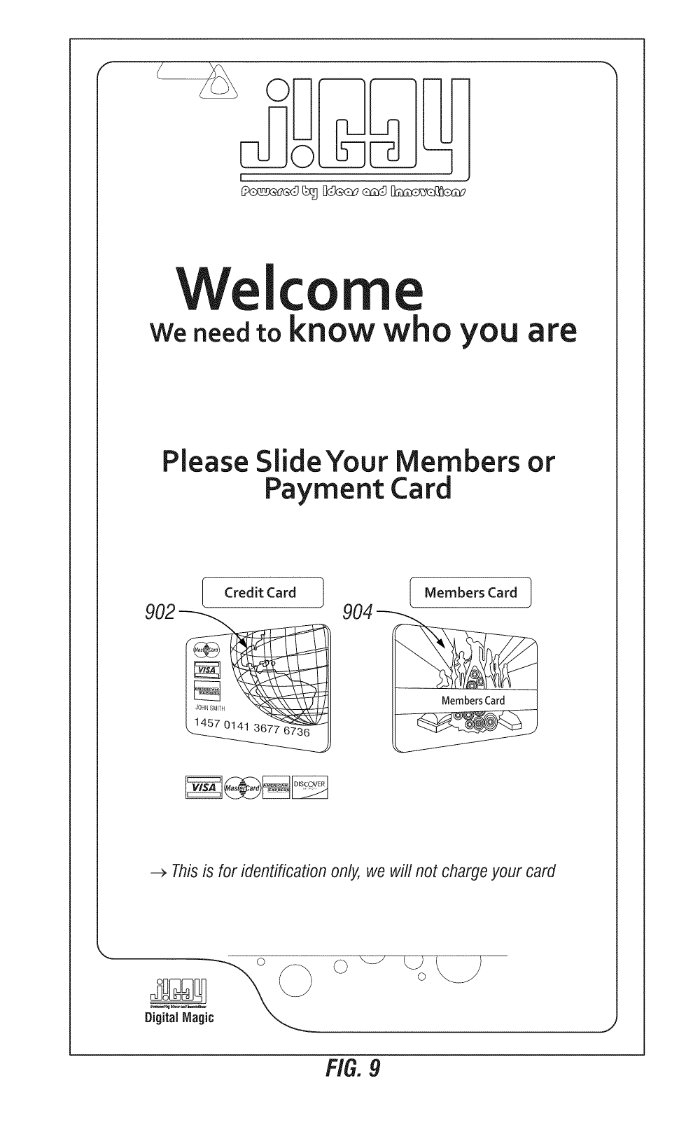

Once a user makes a selection, he or she is presented with a screen as in FIG. 9. FIG. 9 is a depiction of the user interface embodiment showing the welcome screen for a user, requesting that the user insert some form of identification such as a credit card 902 or a member card 904. From the magnetic stripe on a credit card or member card the system is able to extract basic user information to facilitate further transactions.

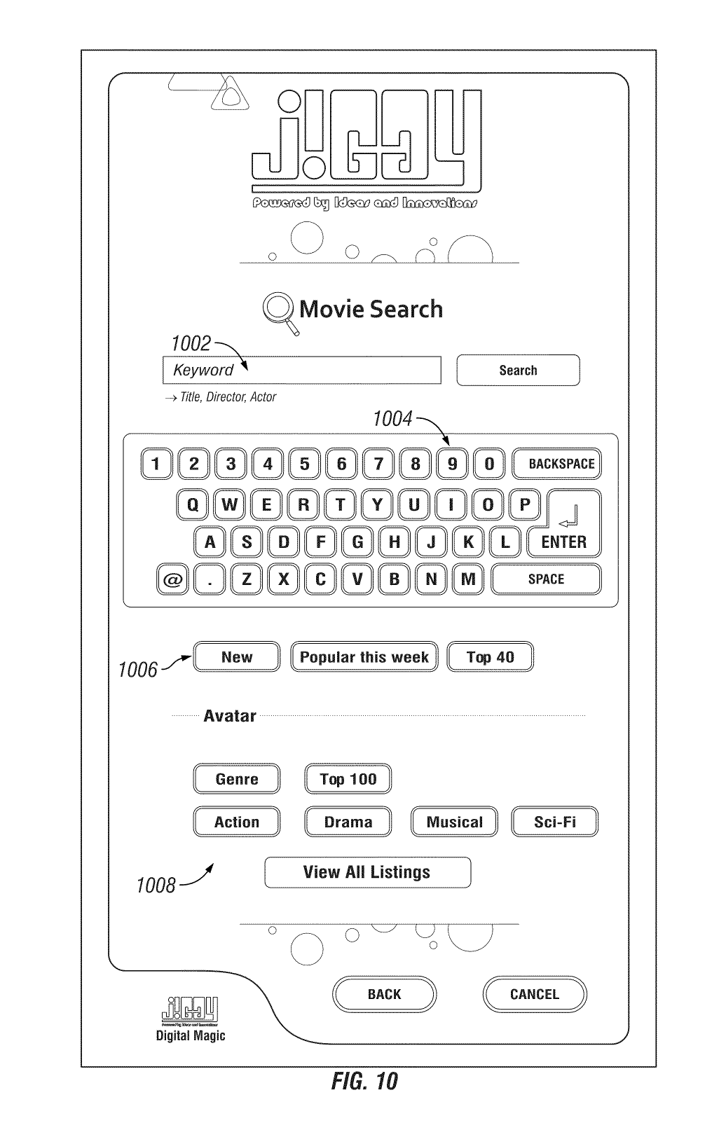

The following example assumes the user has selected the “Movies” feature 802 and has entered his or her identification (902 or 904). The user is then presented with a screen as depicted in FIG. 10. FIG. 10 is a depiction of the user interface embodiment showing the movie search feature. With this feature the user is allowed to enter a keyword 1002 for locating a movie using the virtual keyboard 1004 as presented on the screen. As an alternate means of finding a movie, the user may select the appropriate feature 1006 to display movies that are New, Popular this week, or in the Top 40 as determined by user interest and/or ratings. Still another way to review the movie offerings is by choosing the Genre, category (such as Action, Drama, Musical, Science Fiction, etc.) or a sequential listing of titles 1008.

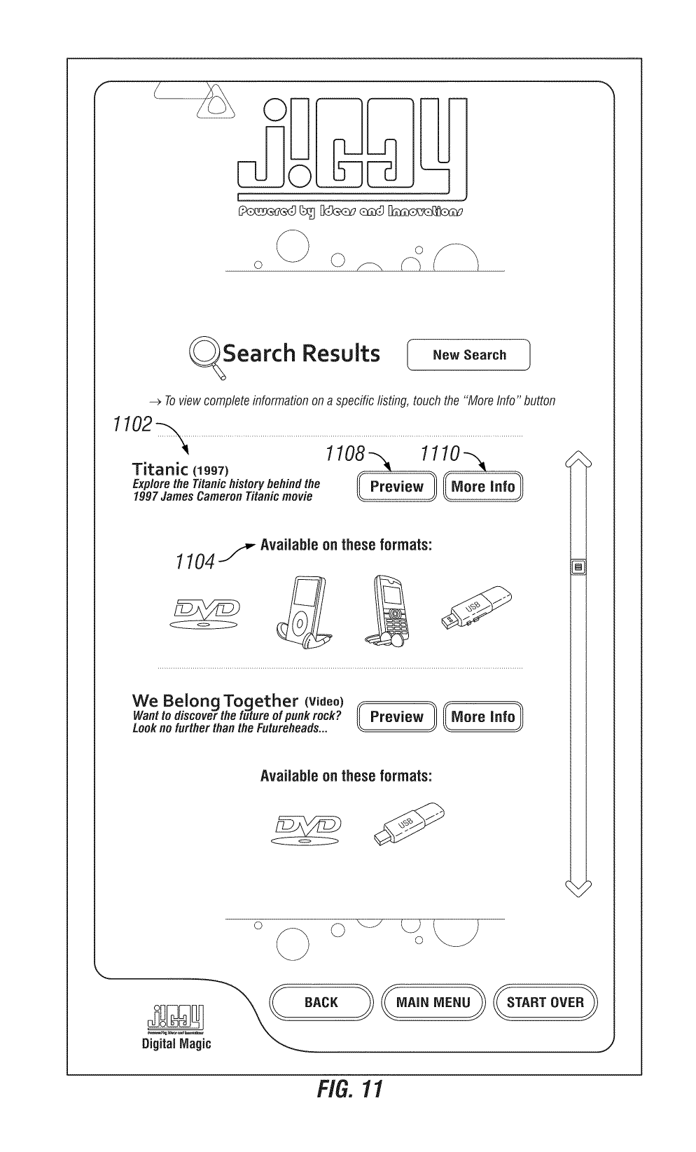

Once a movie title is found, the system displays a screen such as that in FIG. 11. FIG. 11 is a depiction of the user interface embodiment showing the results of a movie search as presented to the user. On this screen information such as movie title 1102 and available formats 1104 is provided. As depicted in this figure, the movie “Titanic” is available in DVD, iPod, MPEG3, and MPEG4 formats. The user may also obtain additional information about the movie 1110 or may obtain a preview 1108.

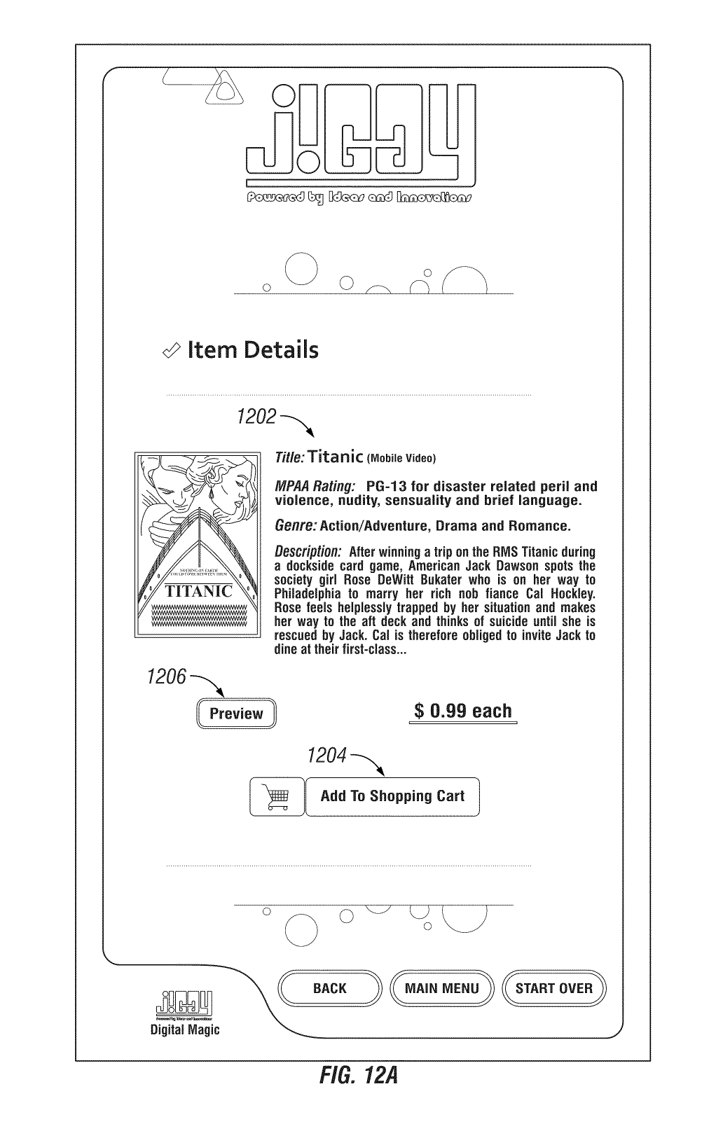

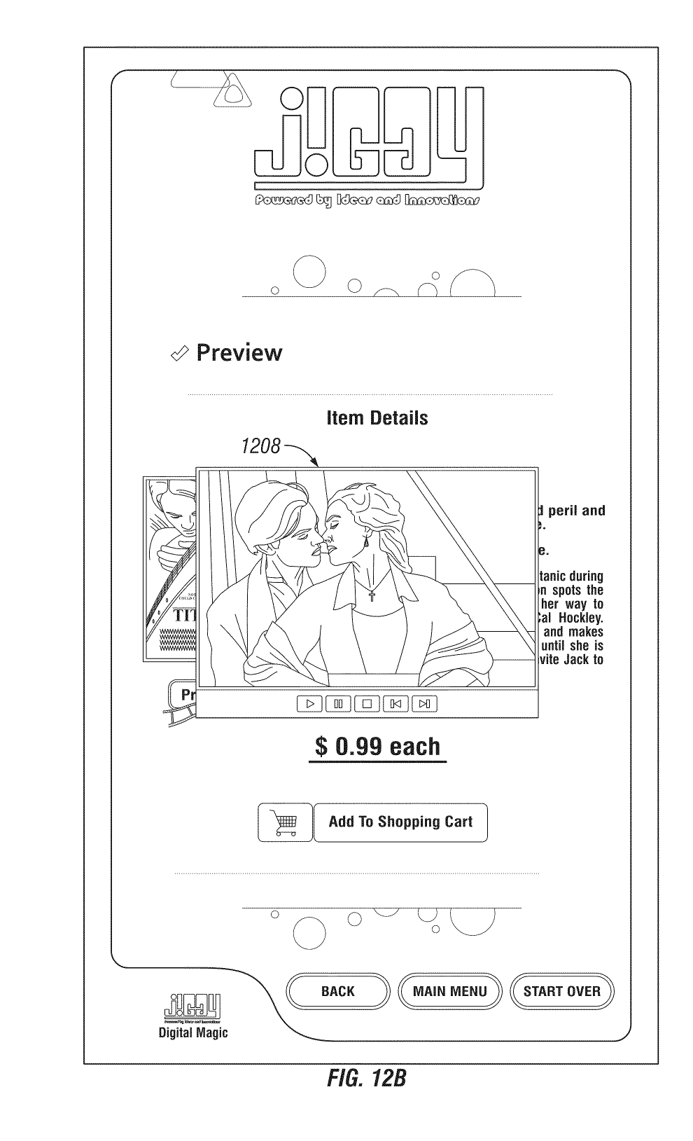

Selecting a movie format icon 1104 causes the system to display a screen such as that depicted in FIG. 12A. FIG. 12A is a depiction of the user interface embodiment showing a specific movie selection chosen by the user, along with detailed information about the title 1202 including cost for the particular format. The user may either add the movie to his or her “Shopping Cart” 1204, or may obtain a preview 1206 before purchase. If the user selects “Preview” 1206, the screen displays a video clip of the movie 1208 as shown in FIG. 12B. FIG. 12B is a depiction of the user interface embodiment showing a preview of the specific movie selection chosen by the user.

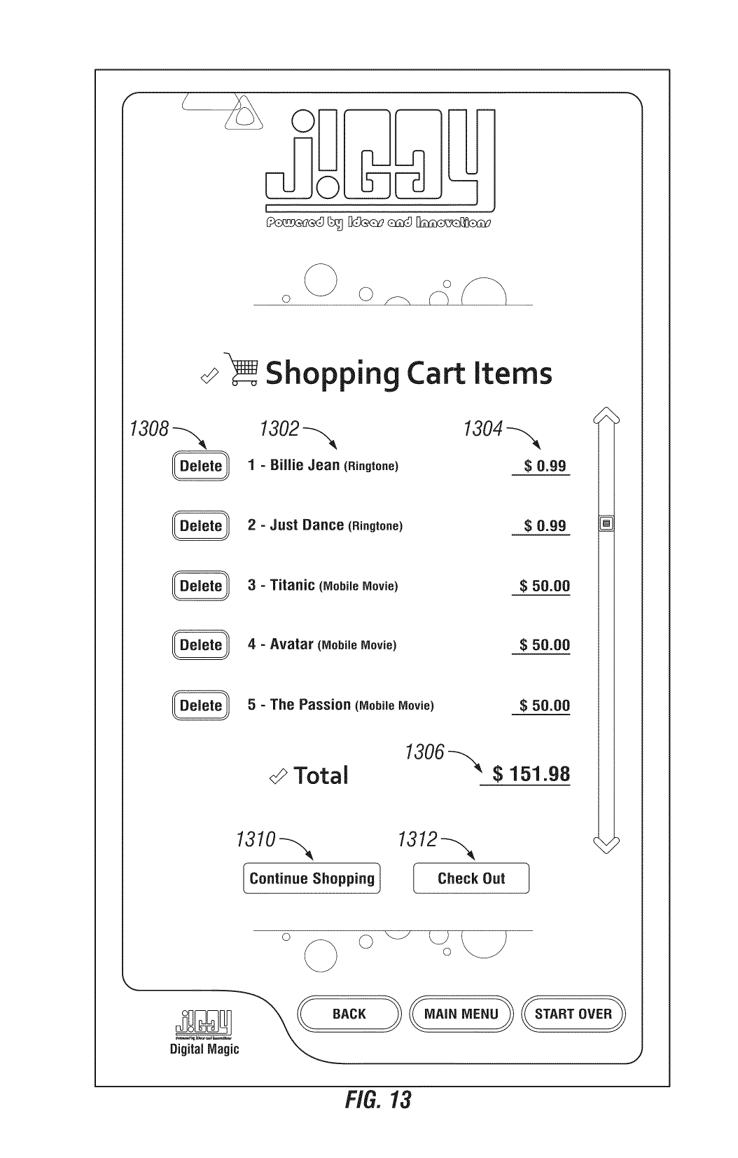

If the user adds the movie to the Shopping Cart 1204, the system displays the Shopping Cart as depicted in FIG. 13. FIG. 13 is a depiction of the user interface embodiment showing the shopping cart feature and contents chosen by the user. The Shopping Cart displays the titles currently selected for purchase 1302 along with the cost of each title 1304 and the total purchase price (minus taxes or special handling) to be billed to the user 1306. The user may then elect to “Continue Shopping” 1310 or may simply “Check Out” 1312 to pay for the purchase and obtain the downloads.

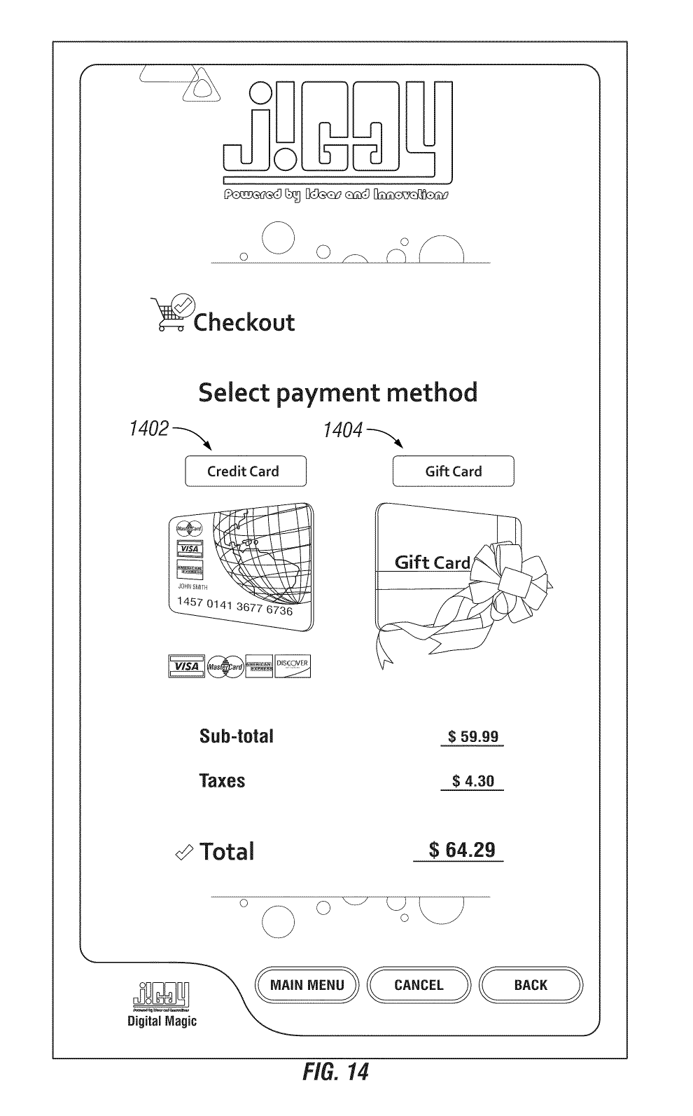

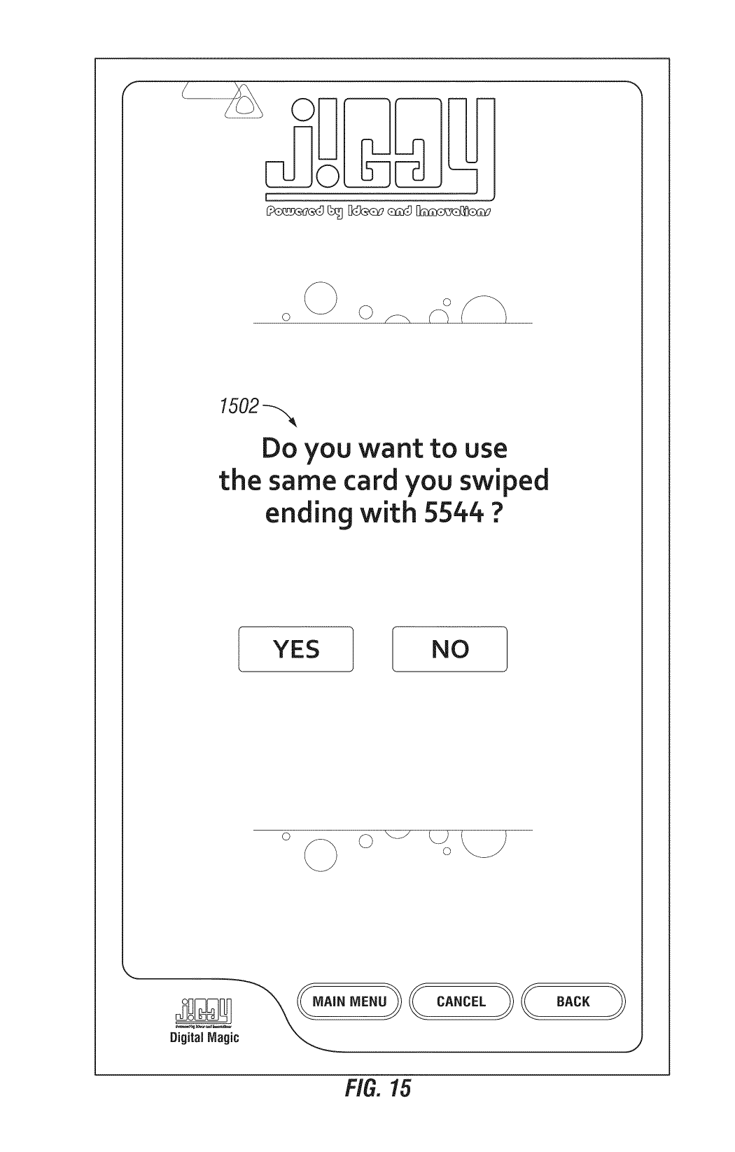

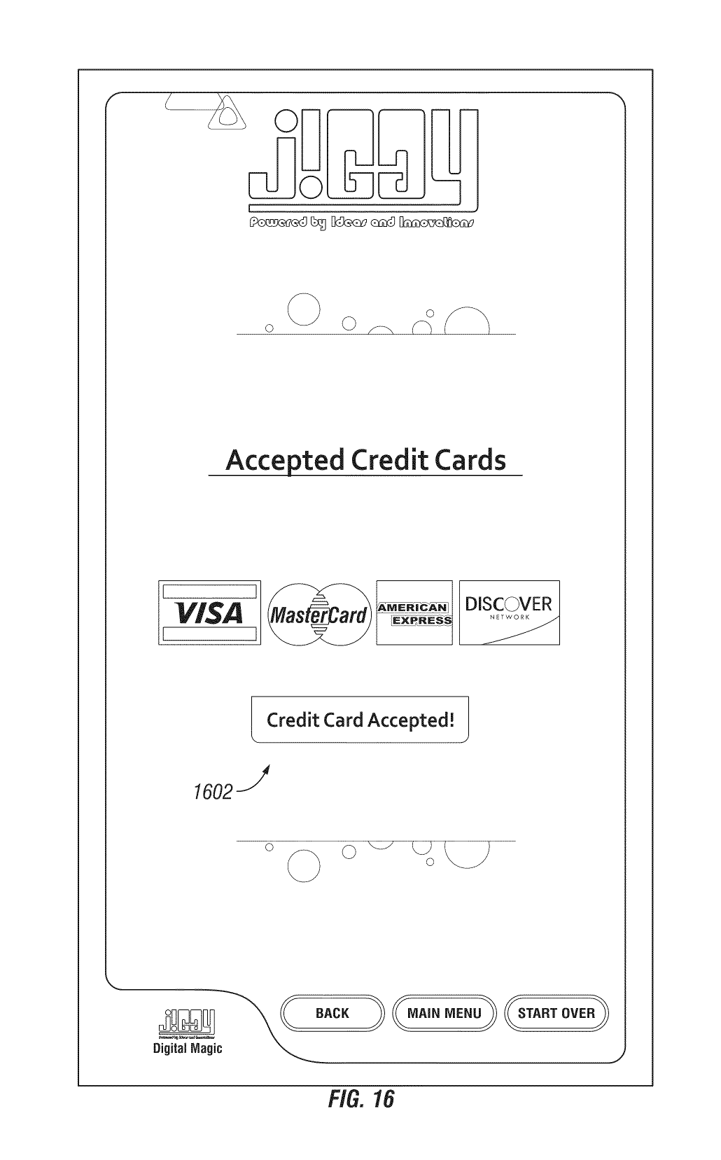

On checkout the user is presented with a screen as depicted in FIG. 14. FIG. 14 is a depiction of the user interface embodiment showing the payment method screen for the user and the total purchase price. The user may elect to pay by credit card 1402 or gift card 1404. Alternate embodiments of the present invention may also include cash handling abilities (similar to an ATM) and may present the user with the option of inserting bills in to a bill handling device. If credit card 1402 is chosen, and the user had swiped the credit card at the outset to supply the system with personal information, the system displays a screen as in FIG. 15. FIG. 15 is a depiction of the user interface embodiment showing the alternate payment prompt screen for the user. The system displays a prompt and asks the user if he or she wishes to bill the purchase to the card swiped at the outset 1502. If the card is accepted and the transaction approved, the system displays a screen such as that in FIG. 16. FIG. 16 is a depiction of the user interface embodiment showing the payment completion screen for the user. As shown, the credit card was accepted 1602.

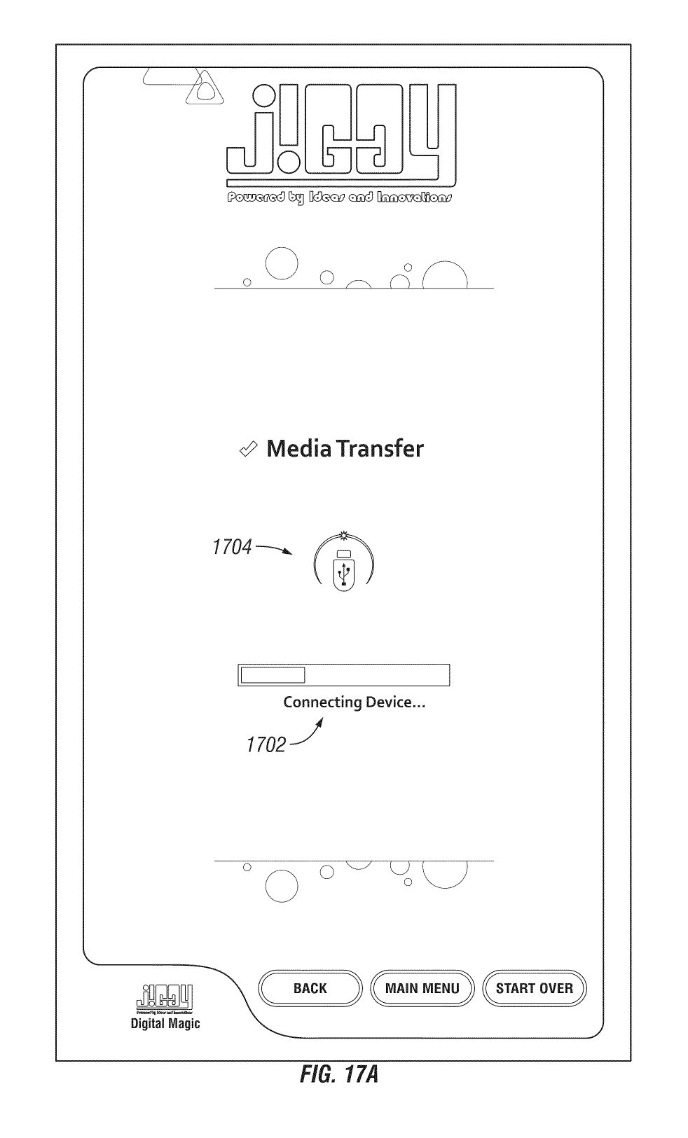

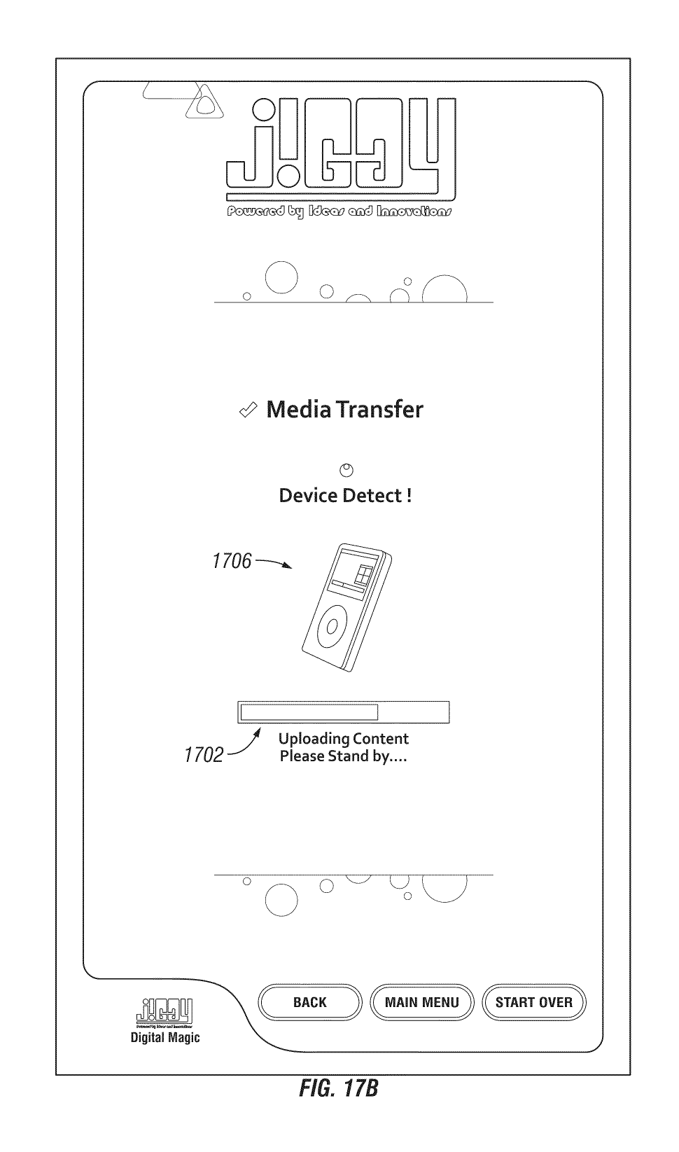

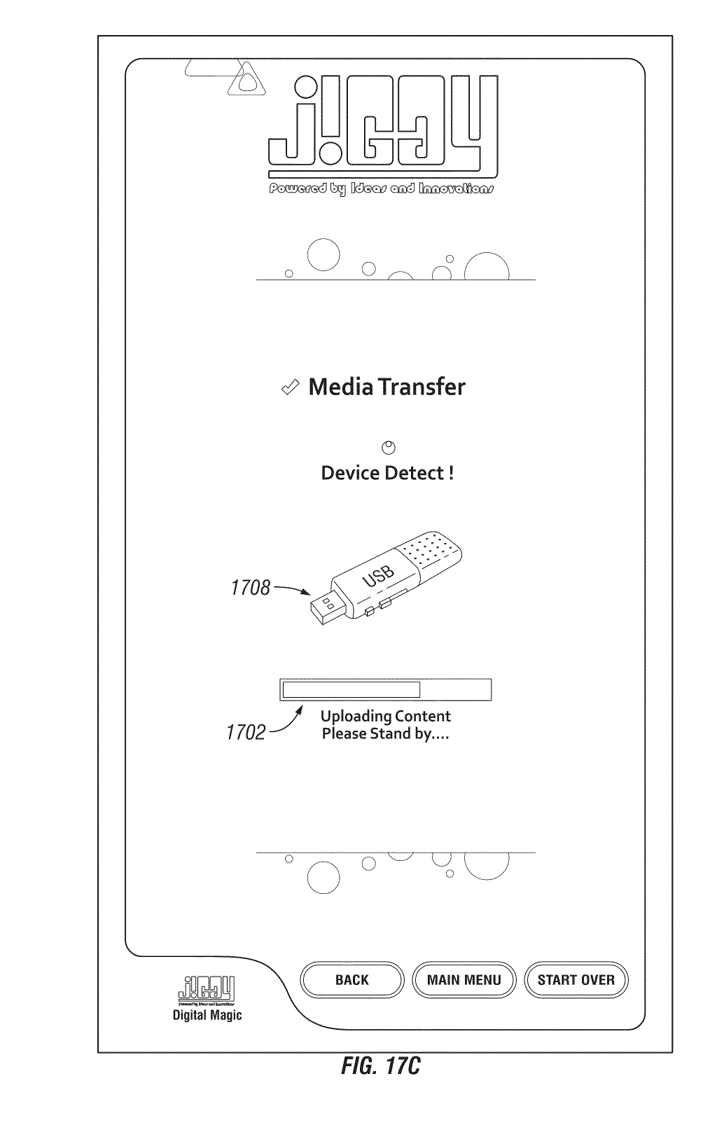

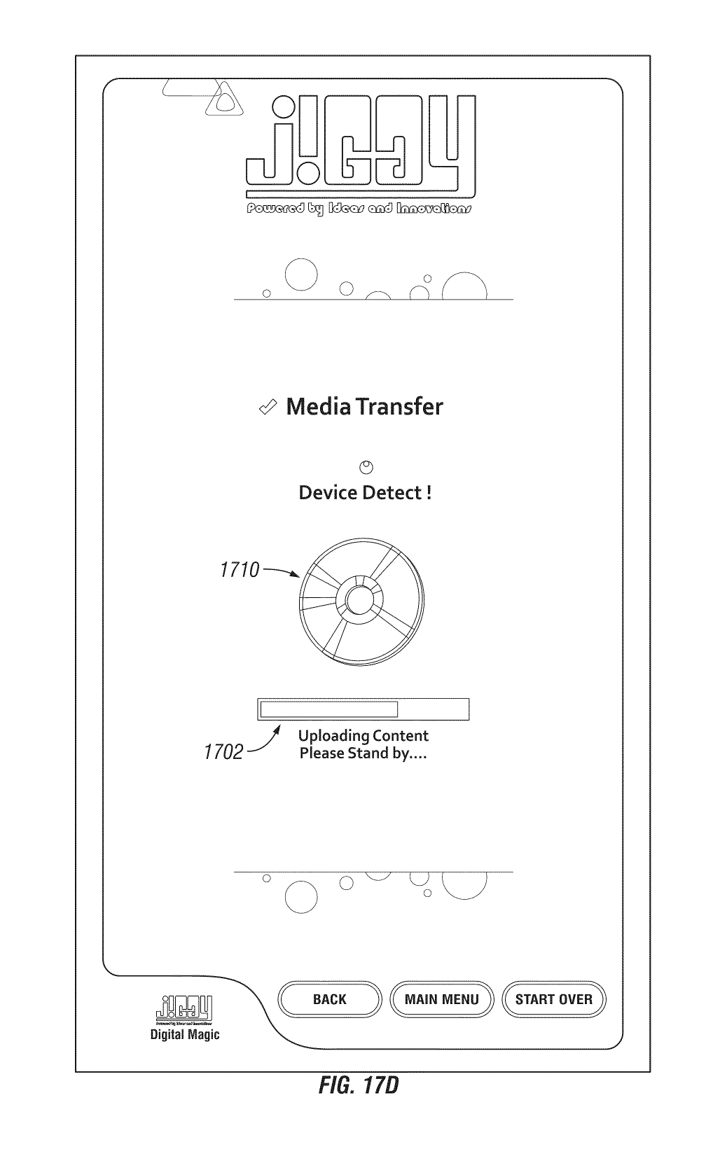

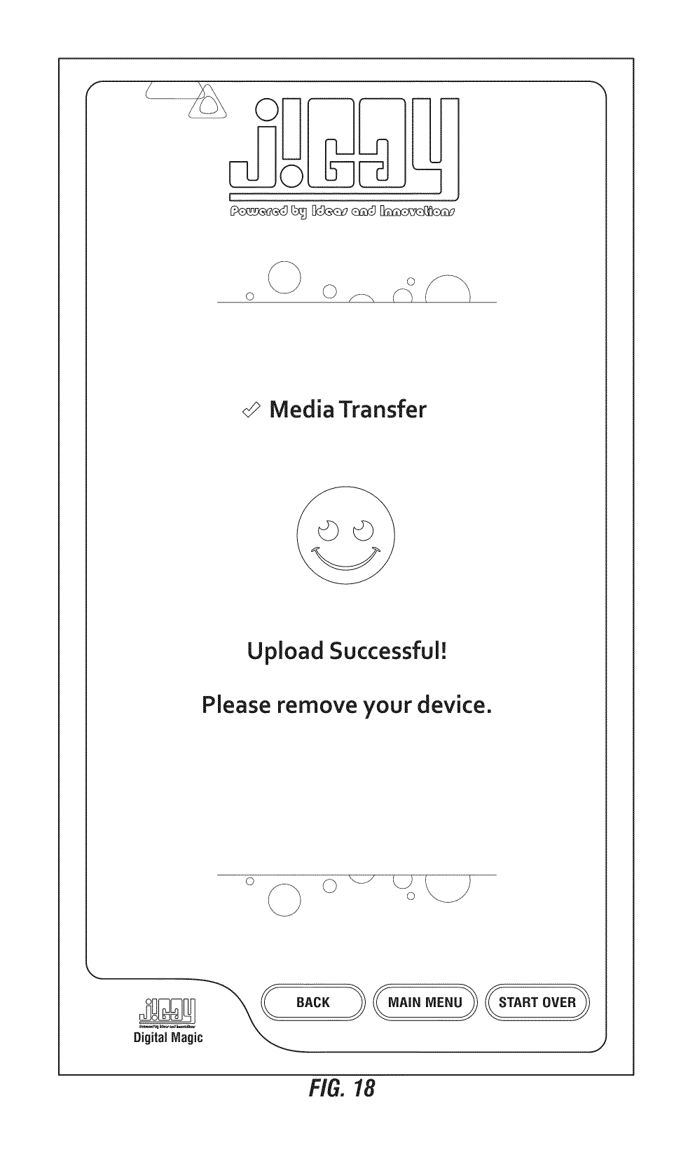

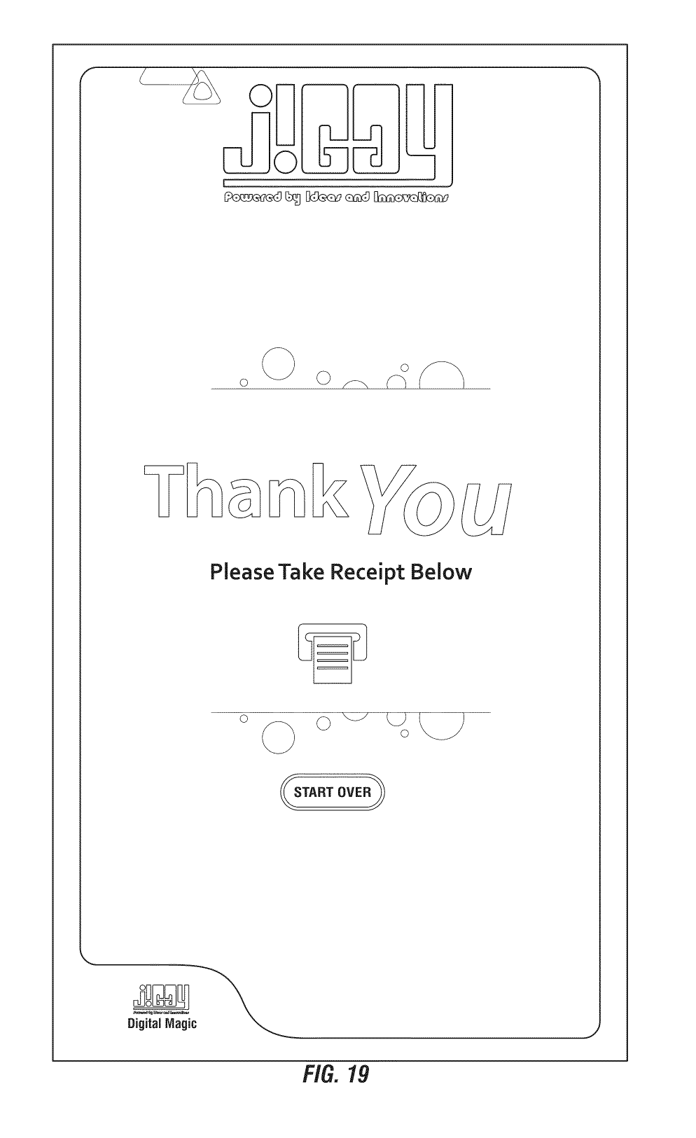

After payment is posted, the user is allowed to download the purchases. The system then displays a screen as in FIG. 17A through 17D, depending on the format chosen. FIG. 17A is a depiction of the user interface embodiment showing the media transfer screen related to a USB connected device 1704, with a status bar depicting status of the transfer 1702. FIG. 17B is a depiction of the user interface embodiment showing the media transfer screen with a status bar 1702 depicting status of the transfer to an iPod® device 1706. FIG. 17C is a depiction of the user interface embodiment showing an alternate media transfer screen for the user, with a status bar 1702 depicting status of the transfer to an USB flash drive device 1708. FIG. 17D is a depiction of the user interface embodiment showing an alternate media transfer screen for the user, with a status bar 1702 depicting status of the transfer to an optical storage device 1710. Once the media transfer is complete, the system presents the user with a screen as depicted in FIG. 18. FIG. 18 is a depiction of the user interface embodiment showing the media transfer completion screen. Payment is then finalized, the receipt is printed, and the user is presented with a screen as shown in FIG. 19. FIG. 19 is a depiction of the user interface embodiment showing the payment completion screen for the user.

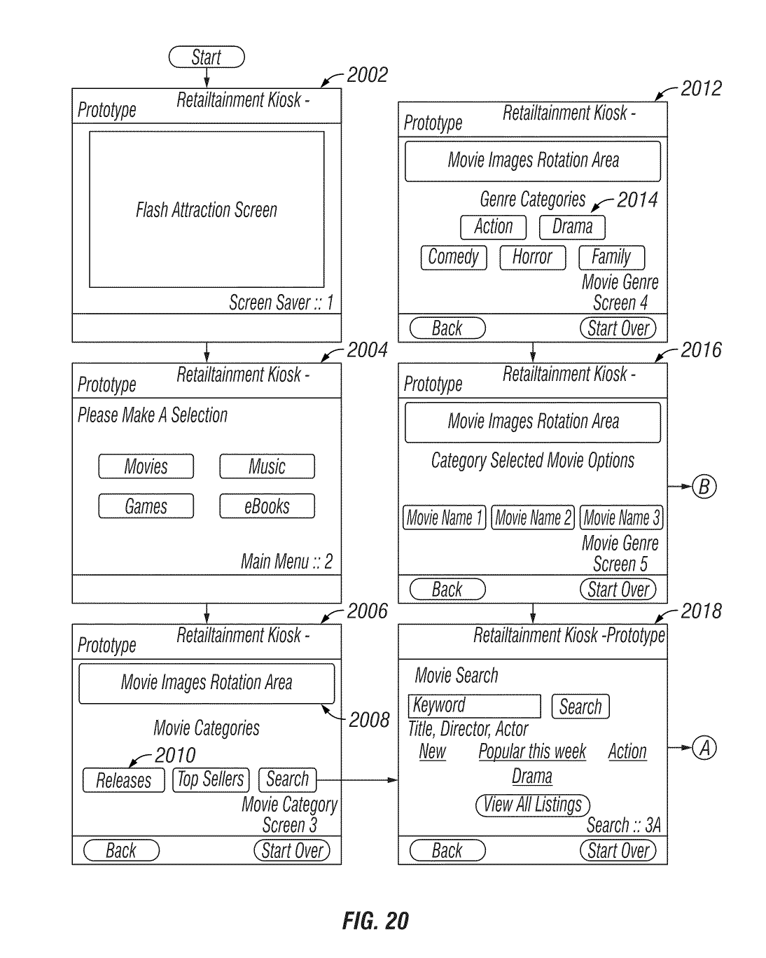

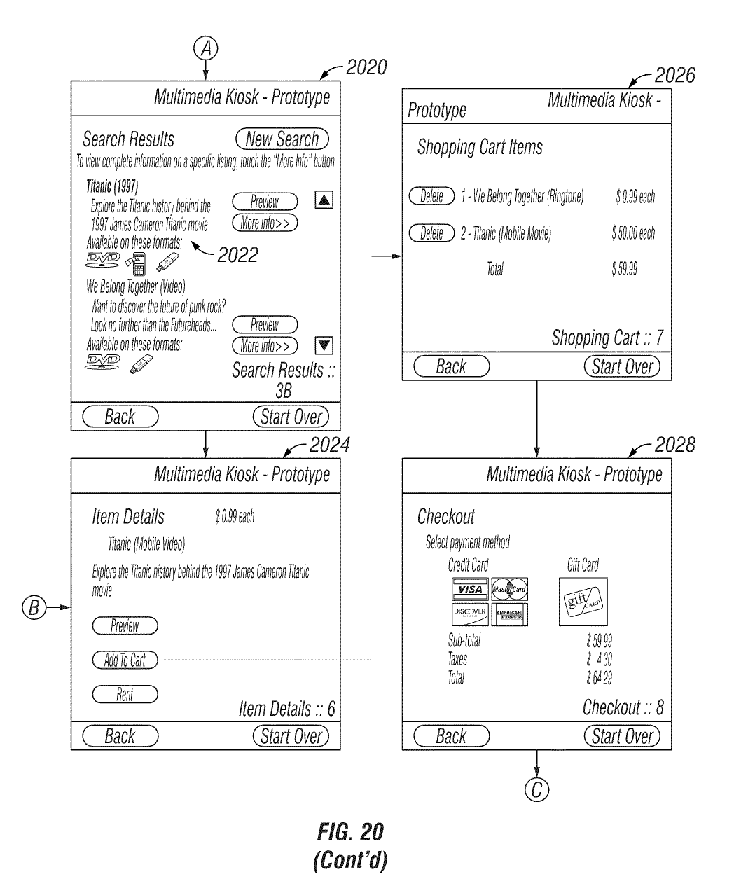

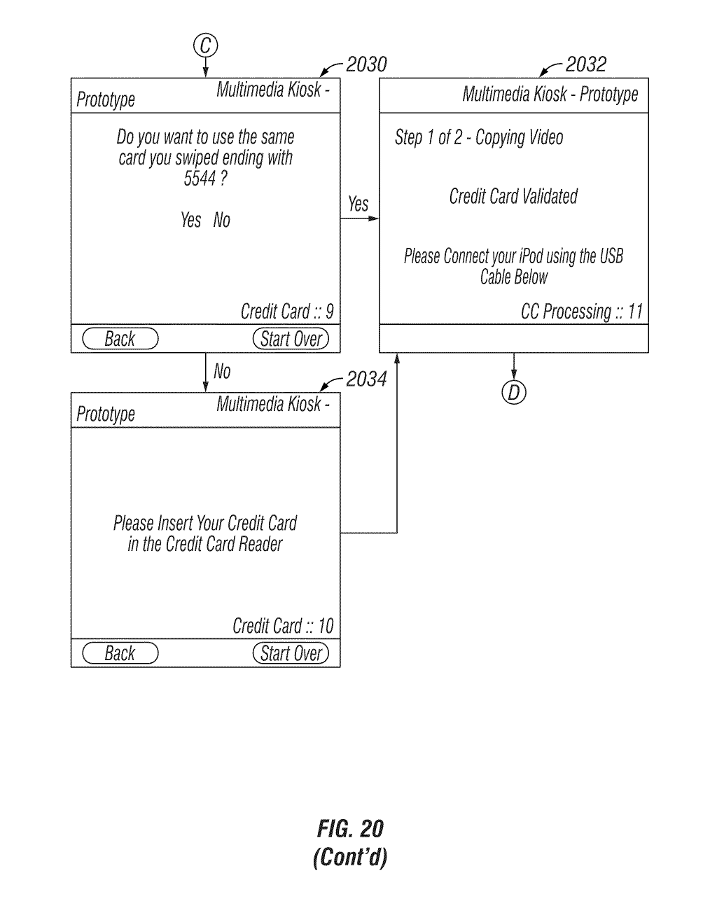

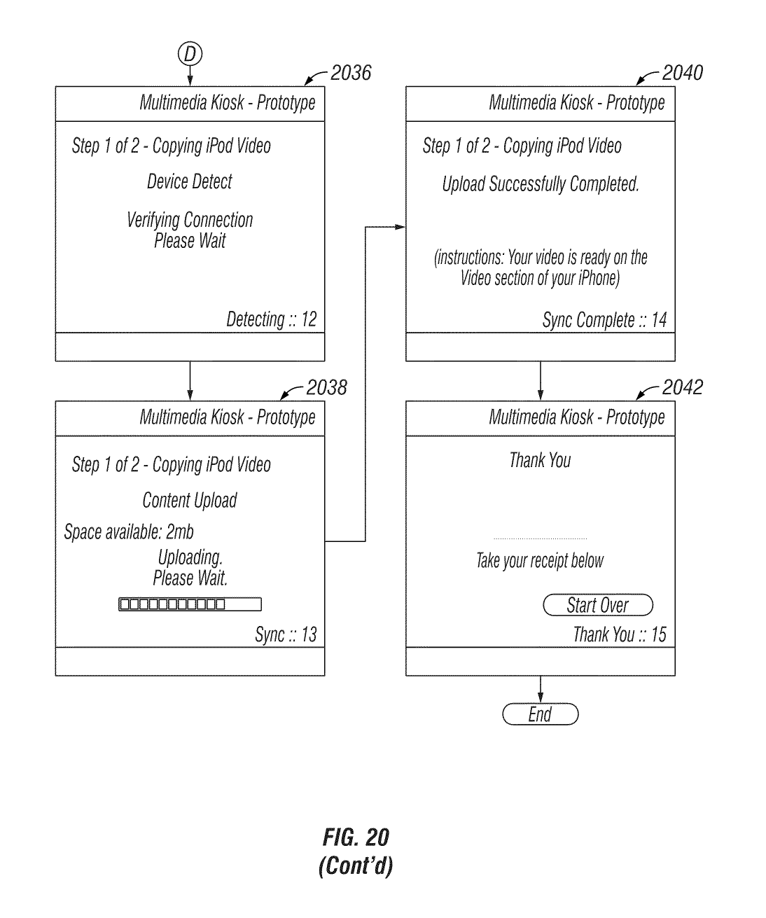

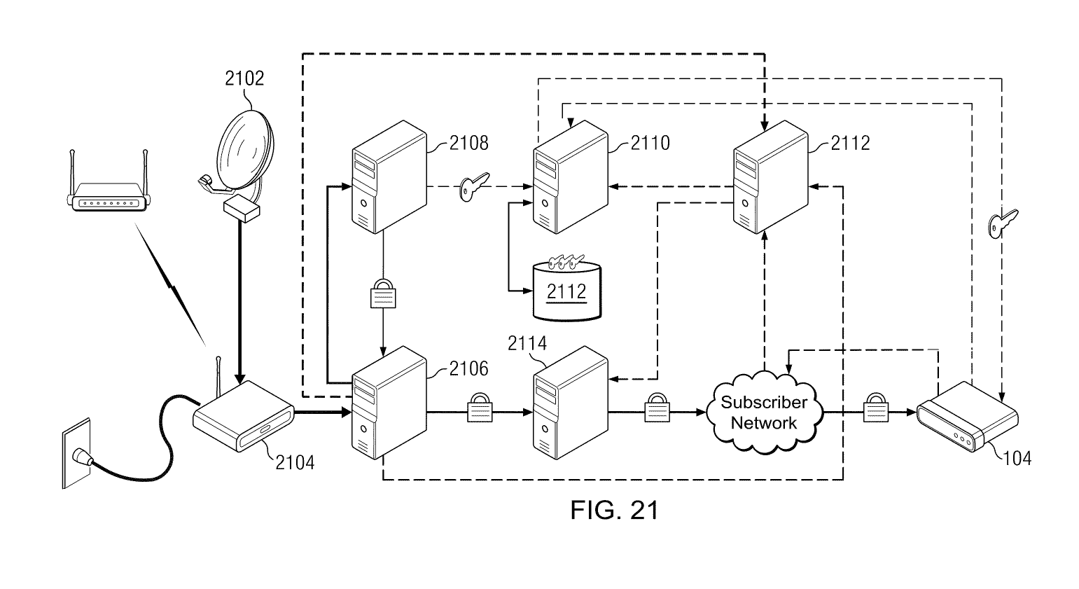

FIG. 20 depicts a flow diagram of yet another embodiment of the present invention. As shown, the user is initially presented with an animated attraction screen 2002 utilizing Adobe® Flash® programming. Such a screen is intended to grab the attention of a user and to increase the user appeal of the system.

After the user touches the screen, he or she is presented with the selection screen 2004. This screen prompts the user to select a media type, such as movies, music, games or electronic books. If the user selects movies, the system will display a screen prompting the user for movie categories (i.e., new releases, top sellers, or general search 2010). An image of a movie, advertisement, or some other marketing banner is also displayed 2008.

Selection of a category advances the user to the genre selection screen 2012. Selection of a genre allows further filtering of the myriad of movie offerings that exist. For example, the user can select among action, drama, comedy, horror, or family movies 2014. Other genres are contemplated and are within the scope of the present invention.

Selection of a genre presents a list of available movie titles 2016. The user can select a specific movie title or may enter the search function 2018 to look for a particular title. Upon entering a keyword search or selecting a specific title, the system presents a screen such as that depicted in 2020. This screen presents the search results and displays the available formats 2022 for each title. Selection of a movie format causes the system to display the item details screen 2024. This gives the user the option of adding the title to his or her shopping cart, or of previewing the title before purchase. The system allows playback of all or a portion of a movie, depending on length.

Upon checkout the user is presented with the shopping cart display 2026. This display presents an itemized breakdown of each of the user's desired purchases. If the user is ready to check out and pay, the system presents the checkout screen 20208, including a subtotal of the purchase and any taxes and fees. The user may choose between credit card payments or gift cards, or may insert cash if a cash acceptance device is attached (such as, for example, the equipment utilized by vending machines to allow acceptance of paper currency).

If the user had originally swiped a credit card to gain initial access to the system, he or she may then be presented with a screen that allows the user to continue the purchase transaction with the card that was originally swiped 2030. Selecting yes will validate the purchase on the earlier used card 2032. Selecting no prompts the user to insert a different card in the card reader 2034.

After payment is verified, the download portion of the transaction is allowed to commence. The system displays a screen such as that in 2036. As depicted, the system enables its device locating feature and waits for a connection with the user's media transport device. This connection may be wireless or wired, and the system automatically detects the type of device to which it will transfer the data. Once the device is located, the system presents a screen as in 2038. This screen includes a download status indicator and typically displays the title being transferred, the amount free space available on the device, and the type of device that is connected. Upon successful completion of the download, the system displays a success screen 2040 and provides any necessary instructions regarding the purchase. A receipt for the transaction is then provided and the transaction is finalized 2042. The receipt may be either a hard copy printout or may even be an emailed message, helping to avoid unnecessary printing.

It will now be evident to those skilled in the art that there has been described herein, universal multimedia distribution, storage, and playback systems and methods. Although the invention hereof has been described by way of a preferred embodiment, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

I claim:

1. A media distribution kiosk apparatus, the apparatus comprising:
a non-volatile digital storage device for the storage of a plurality of unstructured digital media formats, the storage device including an HTTP communication interface.

2. The apparatus of claim 1, wherein the HTTP interface is capable of interfacing with other like-apparatuses for the sharing of storage capacity.

3. The apparatus of claim 1, wherein the HTTP interface is capable of interfacing with other devices having HTTP interface capabilities.

4. The apparatus of claim 1, wherein the HTTP interface is capable of interfacing with other like-apparatuses for the sharing of digital media stored thereon.

5. The apparatus of claim 1, the non-volatile storage device further comprising metadata associated with the digital media stored thereon.

6. The apparatus of claim 1, the non-volatile storage device further comprising metadata associated with the digital media stored thereon, the metadata updatable through social networking services or social networking technologies.

7. The apparatus of claim 1, the non-volatile storage device further comprising metadata associated with the digital media stored thereon, the metadata updatable through social networking services or social networking technologies, the metadata including context data and content data associated with a digital media file.

8. The apparatus of claim 1, wherein the HTTP interface is capable of interfacing with other like-apparatuses for the sharing of digital media stored thereon, the storage device further comprising metadata associated with the digital media files, wherein the storage device is capable of limiting access by users to digital media files based upon the associated metadata.

9. A media distribution system, the system comprising:
a plurality of media distribution kiosks, two or more of the plurality of kiosks including a non-volatile digital storage device for the storage of a plurality of unstructured digital media formats, each storage device including an HTTP communication interface.

10. The system of claim 9, wherein the two or more of the plurality of kiosks are capable of communicating over the HTTP interface for the sharing of storage capacity between connected kiosks.

11. The system of claim 9, wherein the two or more of the plurality of kiosks are capable of communicating over the HTTP interface for the sharing of digital media stored thereon.

12. The system of claim 9, wherein the two or more of the plurality of kiosks are capable of communicating over the HTTP interface for the sharing of digital media stored thereon, the system capable of automatically allocating digital media among connected kiosks based upon digital media demand.

13. The system of claim 9, each non-volatile storage device further comprising metadata associated with the digital media stored thereon.

14. The system of claim 9, each non-volatile storage device further comprising metadata associated with the digital media stored thereon, the metadata updatable through social networking services or social networking technologies.

15. The system of claim 9, each non-volatile storage device further comprising metadata associated with the digital media stored thereon, the metadata updatable through social networking services or social networking technologies, the metadata including context data and content data associated with a digital media file.

16. The system of claim 9, wherein the two or more of the plurality of kiosks are capable of communicating over the HTTP interface for the sharing of digital media stored thereon, each storage device further comprising metadata associated with the digital media files, wherein each storage device is capable of limiting access by users to digital media files based upon the associated metadata.
